(19) United States
(12) Patent Application Publication
(10) Pub. No.: US 2025/0363816 A1
(43) Pub. Date: Nov. 27, 2025

(54) ELECTRONIC APPARATUS AND CONTROLLING METHOD THEREOF

(71) Applicant: SAMSUNG ELECTRONICS CO., LTD., Suwon-si (KR)

(72) Inventors: Donghyun KIM, Suwon-si (KR); Yaeha KWON, Suwon-si (KR); Yoonhee CHOI, Suwon-si (KR)

(73) Assignee: SAMSUNG ELECTRONICS CO., LTD., Suwon-si (KR)

(21) Appl. No.: 19/185,551

(22) Filed: Apr. 22, 2025

Related U.S. Application Data
(63) Continuation of application No. PCT/KR2025/099461, filed on Feb. 19, 2025.

(30) Foreign Application Priority Data
May 27, 2024 (KR) 10-2024-0068813

(51) Int. Cl. G06V 20/68; F25D 29/00

(52) U.S. Cl. CPC G06V 20/68; F25D 29/005; F25D 2700/02; F25D 2700/06

(57) ABSTRACT

An electronic apparatus for storing wine includes a door; memory storing instructions; a camera; and at least one processor, wherein the instructions, when executed by the at least one processor, cause the electronic apparatus to acquire a captured image via the camera based on the door being open; acquire, based on the captured image, wine storage information including a shelf location where a wine object is placed and a wine location of the wine object; acquire wine feature information corresponding to the wine object; store wine information including the wine storage information and the wine feature information in the memory; and transmit the wine information to a user terminal to cause the user terminal to display at least one of the wine storage information, the wine feature information, a storage recommendation based on the wine information, or a food pairing recommendation based on the wine information.

### CROSS-REFERENCE TO RELATED APPLICATIONS

This application is a by-pass continuation application of International Application No. PCT/KR2025/099461, filed on Feb. 19, 2025, which is based on and claims priority to Korean Patent Application No. 10-2024-0068813, filed on May 27, 2024, in the Korean Intellectual Property Office, the disclosures of which are incorporated by reference herein in their entireties.

### BACKGROUND

### 1. Field

The present disclosure relates to an electronic apparatus and a controlling method thereof, and more to an electronic apparatus for storing a target object and providing information related to its storage, and a controlling method thereof.

### 2. Description of Related Art

An apparatus for storing a target object (e.g., wine) may perform a function (e.g., temperature maintenance) related to its storage. The apparatus may include a shelf or container for storing the target object. If a user directly inputs where the target object is stored on the shelf, it may cause user inconvenience.

If the user captures the target object and registers the same on a storage-related server, it may cause the user inconvenience as the user has to capture the wine directly.

If the user captures the wine by using a user terminal each time the user stores the wine, the user inconvenience may occur, such as having to find its storage location, launch a wine application, or check for an internet connection.

During a process of the user directly capturing the wine, a wine recognition rate may drop due to a difference in a capturing condition (e.g., distance between a subject and a lens, or lighting).

If the user attempts to store a large number of wine at the same time, the user inconvenience may occur, such as having to register each wine one by one.

### SUMMARY

According to an aspect of the disclosure, an electronic apparatus for storing wine includes a door; memory storing instructions; a camera; and at least one processor, wherein the instructions, when executed by the at least one processor, cause the electronic apparatus to acquire a captured image via the camera based on the door being open; acquire, based on the captured image, wine storage information including a shelf location where a wine object is placed and a wine location of the wine object; acquire wine feature information corresponding to the wine object; store wine information including the wine storage information and the wine feature information in the memory; and transmit the wine information to a user terminal to cause the user terminal to display at least one of the wine storage information, the wine feature information, a storage recommendation based on the wine information, or a food pairing recommendation based on the wine information.

The electronic apparatus may further include a door sensor, and the instructions, when executed by the at least one processor, may cause the electronic apparatus to acquire the captured image via the camera based on a signal indicating that the door is open being received via the door sensor.

The electronic apparatus may further include a plurality of shelves, and the instructions, when executed by the at least one processor, may cause the electronic apparatus to identify a shelf object in the captured image; acquire a horizontal length of the shelf object; and acquire the shelf location based on the horizontal length of the shelf object and a first mapping table stored in the memory. The first mapping table may include a plurality of horizontal length ranges corresponding to the plurality of shelves.

The instructions, when executed by the at least one processor, may cause the electronic apparatus to acquire, based on the captured image, first coordinate information corresponding to the shelf object; and acquire, based on the first coordinate information, a first outline length of the shelf object in a lowest position in the captured image, from among a plurality of shelf objects in the captured image, as the horizontal length of the shelf object.

The instructions, when executed by the at least one processor, may cause the electronic apparatus to identify, based on the first coordinate information, a plurality of vertices corresponding to the shelf object; identify two vertices adjacent to the camera from among the plurality of vertices; and acquire, as the horizontal length of the shelf object, a second outline length connecting the two vertices to each other.

The instructions, when executed by the at least one processor, may cause the electronic apparatus to identify a horizontal length range corresponding to the horizontal length of the shelf object from among the plurality of horizontal length ranges; and identify a first shelf corresponding to the horizontal length range as a shelf on which the wine object is stored.

The instructions, when executed by the at least one processor, may cause the electronic apparatus to identify the shelf location based on the horizontal length of the shelf object, and the shelf object may be determined to be a further distance from the camera as the horizontal length of the shelf object decreases.

The instructions, when executed by the at least one processor, may cause the electronic apparatus to identify the wine object in the captured image; acquire, based on the captured image, relative location information indicating a location of the wine object in a region of the first shelf; and acquire the wine location based on the relative location information and a second mapping table stored in the memory. The second mapping table may include a plurality of relative location ranges corresponding to a plurality of regions of the plurality of shelves.

The instructions, when executed by the at least one processor, may cause the electronic apparatus to acquire, based on the captured image, first coordinate information corresponding to the shelf object; acquire, based on the first coordinate information, an outline length of the shelf object in a lower direction as the horizontal length of the shelf object; acquire, based on the first coordinate information, a first minimum x-axis value of the shelf object; acquire, based on the captured image, second coordinate information corresponding to the wine object; acquire, based on the second coordinate information, at least one of a second minimum x-axis value of the wine object or a maximum x-axis value of the wine object; acquire the relative location information corresponding to the wine object based on at least one of the second minimum x-axis value or the maximum x-axis value of the wine object, the first minimum x-axis value, or the horizontal length of the shelf object; and acquire the wine location based on the relative location information.

The instructions, when executed by the at least one processor, may cause the electronic apparatus to store a wine sample image in a database through a wine registration process, acquire a first wine sample image corresponding to the wine object if the wine object is identified in the captured image, and acquire the wine feature information based on the first wine sample image. The wine feature information may include at least one of a name, a type, a flavor, a manufacturer, a manufacturing date, an expiration date, a price, or a rating of the wine.

According to an aspect of the disclosure, a controlling method of an electronic apparatus for storing wine includes acquiring a captured image, via a camera, based on a door of the electronic apparatus being open; acquiring, based on the captured image, wine storage information including a shelf location where a wine object is placed and a wine location of the wine object; acquiring wine feature information corresponding to the wine object; storing wine information including the wine storage information and the wine feature information in memory of the electronic apparatus; and transmitting the wine information to a user terminal to cause the user terminal to display at least one of the wine storage information, the wine feature information, a storage recommendation based on the wine information, or a food pairing recommendation based on the wine information.

The acquiring the captured image may include acquiring the captured image based on a signal from a door sensor being received that indicates the door is open.

The acquiring the wine storage information may include identifying a shelf object in the captured image; acquiring a horizontal length of the shelf object; and acquiring the shelf location based on the horizontal length of the shelf object and a first mapping table stored in the electronic apparatus. The first mapping table may include a plurality of horizontal length ranges corresponding to a plurality of shelves of the electronic apparatus.

The acquiring the wine storage information may include acquiring, based on the captured image, first coordinate information corresponding to the shelf object; and acquiring, based on the first coordinate information, a first outline length of the shelf object in a lowest position in the captured image, from among a plurality of shelf objects in the captured image, as the horizontal length of the shelf object.

The acquiring the wine storage information may include identifying, based on the first coordinate information, a plurality of vertices corresponding to the shelf object; identifying two vertices adjacent to the camera from among the plurality of vertices, and acquiring, as the horizontal length of the shelf object, a second outline length connecting the two vertices to each other.

The acquiring the wine storage information may include identifying a horizontal length range corresponding to the horizontal length of the shelf object from among the plurality of horizontal length ranges; and identifying a first shelf corresponding to the horizontal length range as a shelf on which the wine object is stored.

The acquiring the wine storage information may include identifying the shelf location based on the horizontal length of the shelf object, and the shelf object may be determined to be a further distance from the camera as the horizontal length of the shelf object decreases.

The acquiring the wine storage information may include identifying the wine object in the captured image; acquiring, based on the captured image, relative location information indicating a location of the wine object in a region of the first shelf; and acquiring the wine location based on the relative location information and a second mapping table stored in the memory. The second mapping table may include a plurality of relative location ranges corresponding to a plurality of regions of the plurality of shelves.

The acquiring the wine storage information may include acquiring, based on the captured image, first coordinate information corresponding to the shelf object; acquiring, based on the first coordinate information, an outline length of the shelf object in a lower direction as the horizontal length of the shelf object; acquiring, based on the first coordinate information, a first minimum x-axis value of the shelf object; acquiring, based on the captured image, second coordinate information corresponding to the wine object; acquiring, based on the second coordinate information, at least one of a second minimum x-axis value of the wine object or a maximum x-axis value of the wine object; acquiring the relative location information corresponding to the wine object based on at least one of the second minimum x-axis value or the maximum x-axis value of the wine object, the first minimum x-axis value, or the horizontal length of the shelf object; and acquiring the wine location based on the relative location information.

According to an aspect of the disclosure, a non-transitory computer-readable recording medium having instructions recorded thereon, that, when executed by one or more processors, cause the one or more processors to acquire a captured image via a camera based on a door of an electronic apparatus for storing wine being open; acquire, based on the captured image, wine storage information including a shelf location where a wine object is placed and a wine location of the wine object; acquire wine feature information corresponding to the wine object; store wine information including the wine storage information and the wine feature information in memory of the electronic apparatus; and transmit the wine information to a user terminal to cause the user terminal to display at least one of the wine storage information, the wine feature information, a storage recommendation based on the wine information, or a food pairing recommendation based on the wine information.

### BRIEF DESCRIPTION OF THE DRAWINGS

The above and other aspects, features, and advantages of certain embodiments of the present disclosure are more apparent from the following description taken in conjunction with the accompanying drawings, in which:

FIG. 1 is a diagram for describing an electronic apparatus for storing wine according to an embodiment.

FIG. 2 is a block diagram showing the electronic apparatus according to an embodiment.

FIG. 3 is a block diagram for describing a configuration of the electronic apparatus in FIG. 2 according to an embodiment.

FIG. 4 is a diagram for describing an operation of storing wine information according to an embodiment.

FIG. 5 is a diagram for describing an operation of acquiring wine storage information or wine feature information according to an embodiment.

FIG. 6 is a diagram for describing an operation of acquiring the wine storage information according to an embodiment.

FIG. 7 is a diagram for describing an operation of acquiring a shelf location according to an embodiment.

FIG. 8 is a diagram for describing an operation of acquiring a wine location according to an embodiment.

FIG. 9 is a diagram for describing a structure of a shelf included in the electronic apparatus according to an embodiment.

FIG. 10 is a diagram for describing an operation of identifying a shelf object by using an image according to an embodiment.

FIG. 11 is a diagram for describing an operation of identifying the shelf location by using an image according to an embodiment.

FIG. 12 is a diagram for describing a time point for identifying the shelf object.

FIG. 13 is a diagram for describing a table including information for specifying the shelf location.

FIG. 14 is a diagram for describing an operation of identifying the wine location by using an image according to an embodiment.

FIG. 15 is a diagram for describing an operation of identifying a wine object by using an image according to an embodiment.

FIG. 16 is a diagram for describing a table including the information for specifying the wine location according to an embodiment.

FIG. 17 is a diagram for describing an operation of cropping an image according to an embodiment.

FIG. 18 is a diagram for describing an operation of identifying the plurality of wines according to an embodiment.

FIG. 19 is a diagram for describing an operation of acquiring the wine feature information by using a wine server according to an embodiment.

FIG. 20 is a diagram for describing an operation of displaying the wine information according to an embodiment.

FIG. 21 is a diagram for describing an operation of displaying the wine location according to an embodiment.

FIG. 22 is a diagram for describing a situation where the plurality of shelves are included in one image according to an embodiment.

FIG. 23 is a diagram for describing an operation of identifying whether the wine is opened according to an embodiment.

FIG. 24 is a diagram for describing an image conversion operation for a region including the wine object according to an embodiment.

FIG. 25 is a diagram for describing an operation of registering a wine image to the electronic apparatus according to an embodiment.

FIG. 26 is a diagram for describing an operation of acquiring the wine feature information by using the registered wine image according to an embodiment.

FIG. 27 is a diagram for describing a wine image database according to an embodiment.

FIG. 28 is a diagram for describing an operation of acquiring the wine feature information by using a server according to an embodiment.

FIG. 29 is a diagram for describing an operation of providing the wine information according to an embodiment.

FIG. 30 is a diagram for describing an operation of providing the wine information by a user terminal according to an embodiment.

FIG. 31 is a diagram for describing an operation of providing a user interface (UI) for inputting the wine feature information according to an embodiment.

FIG. 32 is a diagram for describing an operation of providing a UI for inputting the wine feature information by the user terminal according to an embodiment.

FIG. 33 is a diagram for describing a UI for inputting the wine feature information according to an embodiment.

FIG. 34 is a diagram for describing a UI for inputting the wine feature information according to an embodiment.

FIG. 35 is a diagram for describing a controlling method of an electronic apparatus according to an embodiment.

### DETAILED DESCRIPTION

The embodiments described in the disclosure, and the configurations shown in the drawings, are only examples of embodiments, and various modifications may be made without departing from the scope and spirit of the disclosure.

Throughout the accompanying drawings, similar components are denoted by similar reference numerals.

A singular noun corresponding to an item is intended to include one or more of the items, unless a relevant context clearly indicates otherwise.

In the present disclosure, an expression “A or B”, “at least one of A and B”, “at least one of A or B”, “A, B, or C”, “at least one of A, B, and C”, “at least one of A, B, or C”, or the like may include any one of the items enumerated together or all possible combinations thereof.

A term “and/or” includes a combination of a plurality of related components or any one of the plurality of related components, described herein.

A term such as “first” or “second” may be used to distinguish one element from another element, and does not limit the corresponding component in any other respect (e.g., importance or order).

In addition, terms such as “front surface”, “rear surface”, “upper surface”, “lower surface”, “side surface”, “left side”, “right side”, “upper portion”, “lower portion”, and the like used in the present disclosure are defined based on the drawings. The shapes and positions of respective components are not limited to these terms.

It should be understood that terms “include”, “have”, or the like specify the presence of features, numerals, steps, operations, components, parts, or combinations thereof, described in the present disclosure, and do not preclude the presence or addition of one or more other features, numerals, steps, operations, components, parts, or combinations thereof.

If a component is referred to as being “connected”, “coupled”, “supported”, or “in contact” with another component, it includes not only a case where the components are directly connected, coupled, supported, or in contact with each other, but also a case where the components are indirectly connected, coupled, supported, or in contact with each other through a third component.

If a component is referred to as being disposed “on” another component, it includes not only a case where the component is in contact with another component, but also a case where yet another component is present between the two components.

A refrigerator according to an embodiment may include a main body.

The “main body” may include an interior, an exterior disposed outside the interior, and an insulation material disposed between the interior and the exterior.

The “interior” may include at least one of a case, a plate, a panel, or a liner that forms a storage compartment. The interior may be formed as one body or may be formed by assembling the plurality of plates. The “exterior” may form an appearance of the main body, and may be coupled to the outside of the interior for the insulation material to be disposed between the interior and the exterior.

The “insulation material” may insulate the inside of the storage compartment and the outside of the storage compartment from each other for a temperature inside the storage compartment to be maintained at a set appropriate temperature without being affected by an external environment of the storage compartment. According to an embodiment, the insulation material may include a foam insulation material. The foam insulation material may be formed by injecting and foaming urethane foam, in which polyurethane and a foam agent are mixed with each other, between the interior and the exterior.

According to an embodiment, the insulation material may further include a vacuum insulation material in addition to the foam insulation material, or the insulation material may only include the vacuum insulation material instead of the foam insulation material. The vacuum insulation material may include a core material and an envelope material that accommodates the core material and seals its interior with vacuum or a near-vacuum pressure. The insulation material is not limited to the foam insulation material or the vacuum insulation material, described above, and may include a variety of materials capable of being used for the insulation.

The “storage compartment” may include a space defined by the interior. The storage compartment may further include an interior that defines a space corresponding to the storage compartment. The storage compartment may store various items such as food, medicine, and cosmetics, and the storage compartment may have at least one side that is open for putting in and out these items.

The refrigerator may include one or more storage compartments. In case that two or more storage compartments are formed in the refrigerator, each storage compartment may have a different purpose and be maintained at a different temperature. To this end, the respective storage compartments may be partitioned from each other by a partition including the insulation material.

The storage compartment may maintain an appropriate temperature range based on its purpose, and include a “refrigerator compartment”, a “freezer compartment”, or a “variable temperature compartment”, classified by its purpose and/or temperature range. The refrigerator compartment may be maintained at a temperature for refrigerating and storing an item, and the freezer compartment may be maintained at a temperature for freezing and storing the item. “Refrigeration” may indicate cooling the item to a temperature at which the item is not frozen. For example, the refrigerator compartment may be maintained in a range of 0 degrees Celsius to +7 degrees Celsius. “Freezing” may indicate freezing the item or cooling the item so that the item remains frozen. For example, the freezer compartment may be maintained in a range of −20 degrees Celsius to −1 degree Celsius. The variable temperature compartment may be used as either the refrigerator compartment or the freezer compartment, with or without a user selection.

The storage compartment may be referred to by any of various names such as a “vegetable compartment”, a “fresh compartment”, a “cooling compartment”, or an “ice compartment” in addition to the name such as the “refrigerator compartment”, the “freezer compartment” or the “variable temperature compartment”. The terms such as the “refrigerator compartment”, the “freezer compartment”, and the “variable temperature compartment” used hereinafter should be understood as indicating a concept encompassing the storage compartments each having the corresponding purpose and temperature range.

According to an embodiment, the refrigerator may include at least one door that opens and closes the open side of the storage compartment. The door may be disposed to open or close each of one or more storage compartments, or one door may be disposed to open and close the plurality of storage compartments. The door may be rotatably or slidably installed on a front surface of the main body.

The “door” may seal the storage compartment in case that the door is closed. The door may include the insulation material like the main body to insulate the storage compartment in case that the door is closed.

According to an embodiment, the door may include a door exterior plate which forms a front surface of the door, a door interior plate which forms a rear surface of the door and faces the storage compartment, an upper cap, a lower cap, and a door insulation material disposed therein.

A gasket that seals the storage compartment by adhering to the front surface of the main body in case that the door is closed may be disposed on a border of the door interior plate. The door interior plate may include a dyke that protrudes rearward to enable a door basket for storing the item to be mounted thereon.

According to an embodiment, the door may include a door body and a front panel that is detachably coupled to a front side of the door body and forms the front surface of the door. The door body may include the door exterior plate which forms a front surface of the door body, the door interior plate which forms a rear surface of the door body and faces the storage compartment, the upper cap, the lower cap, and the door insulation material disposed therein.

The refrigerator may be classified into a French door type, a side-by-side type, a bottom mounted freezer (BMF), a top mounted freezer (TMF), a one-door refrigerator, or the like based on the arrangement of the door and the storage compartment.

According to an embodiment, the refrigerator may include a cold air supply device for supplying cold air to the storage compartment.

The “cold air supply device” may include a machine, device, an electronic apparatus, and/or a combination system capable of generating cold air and directing the cold air to cool the storage compartment.

According to an embodiment, the cold air supply device may generate the cold air through a refrigeration cycle that includes the compression, condensation, expansion, and evaporation processes of a refrigerant. To this end, the cold air supply device may include a refrigeration cycle device having a compressor, a condenser, an expansion device and an evaporator capable of driving the refrigeration cycle. According to an embodiment, the cold air supply device may include a semiconductor such as a thermoelectric element. Thermoelectric element may cool the storage compartment through heating and cooling using the Peltier effect.

According to an embodiment, the refrigerator may include a machine room where at least some parts included in the cold air supply device are disposed.

The “machine room” may be partitioned or insulated from the storage compartment to prevent heat generated from the part disposed in the machine room from being transferred to the storage compartment. The inside of the machine room may communicate with the outside of the main body to dissipate heat from the part disposed in the machine room.

According to an embodiment, the refrigerator may include a dispenser disposed on the door to dispense water and/or ice. The dispenser may be disposed on the door for a user to access the dispenser without opening the door.

According to an embodiment, the refrigerator may include an ice maker for producing ice. The ice maker may include an ice-making tray that stores water, an ice-moving device that separates ice from the ice-making tray, and an ice bucket that stores ice produced in the ice-making tray.

According to an embodiment, the refrigerator may include a controller for controlling the refrigerator.

The “controller” may include a memory that stores or retains a program and/or data for controlling the refrigerator, and a processor that outputs a control signal to control the cold air supply device or the like based on the program and/or the data, stored in the memory.

The memory may store or record various information, data, instructions, programs, or the like to operate the refrigerator. The memory may retain temporary data generated while generating the control signal to control the components included in the refrigerator. The memory may include at least one of a volatile memory or a non-volatile memory, or a combination of these memories.

The processor may control overall operations of the refrigerator. The processor may control the components of the refrigerator by executing the program stored in the memory. The processor may include a separate neural processing unit (NPU) that performs an operation of an artificial intelligence model. The processor may include a central processing unit, a graphics-processing unit (GPU), or the like. The processor may generate the control signal to control the operation of the cold air supply device. For example, the processor may receive temperature information of the storage compartment from a temperature sensor, and generate a cooling control signal to control the operation of the cold air supply device based on the temperature information of the storage compartment.

The processor may process a user input through a user interface and control an operation of the user interface based on the program and/or data retained/stored in the memory. The user interface may be provided using an input interface and an output interface. The processor may receive the user input through the user interface. The processor may transfer, to the user interface, a display control signal and image data to display an image on the user interface in response to the user input.

The processor and the memory may be disposed integrally or separately. The processor may include one or more processors. For example, the processor may include a main processor and at least one sub processor. The memory may include one or more memories.

According to an embodiment, the refrigerator may include the processor that controls all the components included in the refrigerator and the memory, and include a plurality of processors that individually control the components of the refrigerator and a plurality of memories. For example, the refrigerator may include the processor that controls the operation of the cold air supply device based on output of the temperature sensor and the memory. The refrigerator may be separately equipped with the processor that controls the operation of the user interface based on the user input and the memory.

A communication module may communicate with an external device such as a server, a mobile device, or another home appliance through a nearby access point (AP). The access point (AP) may connect a local area network (LAN), to which the refrigerator or a user device is connected, to a wide area network (WAN) to which the server is connected. The refrigerator or the user device may be connected to the server through the wide area network (WAN).

The input interface may include a key, a touch screen, a microphone, or the like. The input interface may receive the user input and transfer the same to the processor.

The output interface may include a display, a speaker, or the like. The output interface may output various notifications, messages, information, or the like generated by the processor.

The refrigerator according to the various embodiments is described below with reference to the accompanying drawings.

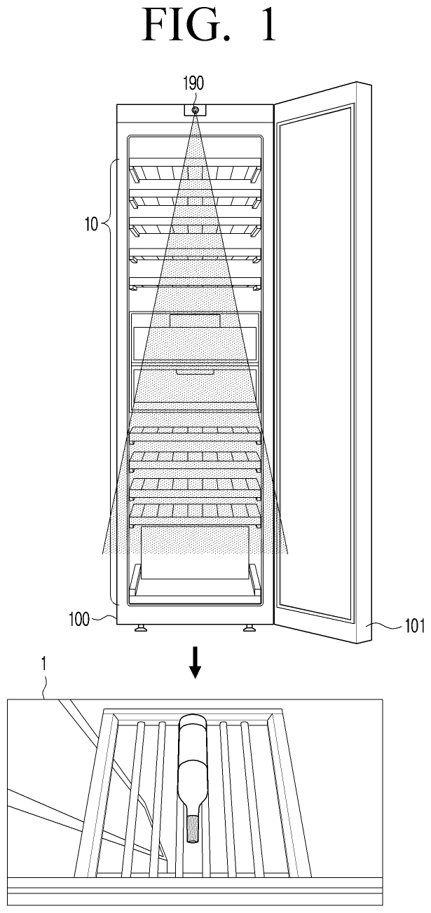

FIG. 1 is a diagram for describing an electronic apparatus 100 for storing wine according to an embodiment.

The electronic apparatus 100 may be an apparatus that performs a refrigeration function. The electronic apparatus 100 may be the refrigerator. The electronic apparatus 100 may store an object. The electronic apparatus 100 may perform the refrigeration function to maintain a temperature of the object.

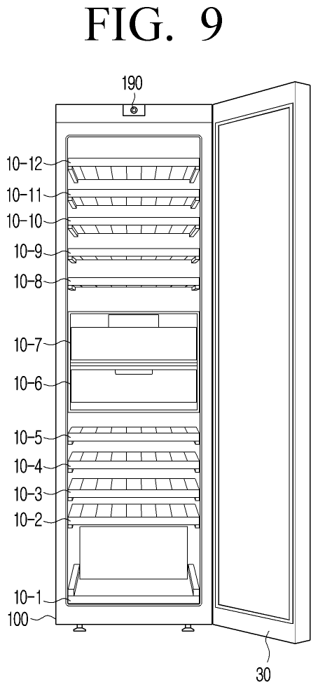

The electronic apparatus 100 may include a door 101. The door 101 may be opened or closed by a physical force of the user or by an electrical force included in the electronic apparatus 100. The electronic apparatus 100 may include at least one shelf 10. The plurality of shelves are described with reference to FIG. 9.

According to an embodiment, the electronic apparatus 100 may be a wine refrigerator or a wine cellar for storing wine.

An object stored in the electronic apparatus 100 is described as the wine. According to the various embodiments, another object instead of the wine may be stored in the electronic apparatus 100.

The electronic apparatus 100 may include a camera 190. The electronic apparatus 100 may capture the object (e.g., wine) stored in the electronic apparatus 100 by using the camera 190. The electronic apparatus 100 may acquire a captured image 1 by using the camera 190.

The electronic apparatus 100 may acquire the captured image 1 corresponding to a predetermined capturing direction based on an arrangement angle of the camera 190 or the like. The captured image 1 may include at least one of the shelf or wine. The camera 190 may be disposed on at upper end part of a front surface of the electronic apparatus 100.

The electronic apparatus 100 may acquire wine information based on the captured image 1. The wine information may include information related to the wine stored in the electronic apparatus 100.

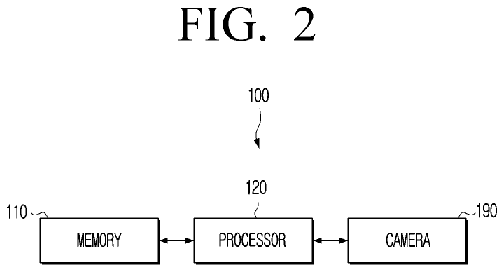

FIG. 2 is a block diagram showing the electronic apparatus 100 according to an embodiment.

Referring to FIG. 2, the electronic apparatus 100 may include the door 101, a memory 110, the camera 190, at least one processor 120.

The door 101 may be connected to the main body of the electronic apparatus 100. A power state of the camera 190 may vary depending on whether the door 101 is opened.

The memory 110 may store the wine information acquired from the electronic apparatus 100.

The camera 190 may be an image sensor for performing a capturing function. The camera 190 may acquire the captured image. The camera 190 may be disposed at the predetermined angle to acquire the captured image including the shelf or the wine.

The electronic apparatus 100 may be a storage or preservation device that stores a target object. The electronic apparatus 100 may be an apparatus that performs the refrigeration function for storing the target object in a predetermined temperature range. The electronic apparatus 100 may be the refrigerator. The target object may be a liquid, such as a beverage or an alcoholic beverage. According to the various embodiments, the target object may be food.

According to an embodiment, the target object may be the wine, and the electronic apparatus 100 may be the wine refrigerator. According to the various embodiments, another object other than the wine may be stored. In the description below, the wine may be described as the target object. The electronic apparatus 100 may also be described as the target object storage device or the like instead of the wine refrigerator.

At least one processor 120 may perform overall control operations of the electronic apparatus 100. At least one processor 120 may perform a function of controlling overall operations of the electronic apparatus 100.

At least one processor 120 may acquire the captured image by using the camera 190 if the door 101 is opened, acquire wine storage information including a shelf location where the wine is placed and a wine location based on the captured image, acquire wine feature information corresponding to the wine, and store the wine information including the wine storage information and the wine feature information in the memory 110.

At least one processor 120 may transmit the wine information to a user terminal to cause the user terminal to display at least one of the wine storage information, the wine feature information, a storage recommendation based on the wine information, or a food pairing recommendation based on the wine information.

At least one processor 120 may identify whether the door 101 is opened. If the door 101 is opened, at least one processor 120 may acquire the captured image by using the camera 190. The captured image may be a red-green-blue (RGB) image. If the door 101 is not opened, at least one processor 120 may maintain the camera 190 in a power-off or power-saving state. At least one processor 120 may acquire the captured image only if an event of the door 101 being opened is identified.

The door 101 may be opened or closed by the physical force of the user.

The door 101 may be opened or closed by the electrical force provided by the electronic apparatus 100.

The electronic apparatus 100 may further include a door sensor.

At least one processor 120 may acquire (or receive) sensing data through the door sensor. At least one processor 120 may determine whether the door 101 is opened based on the sensing data. At least one processor 120 may receive a predetermined signal based on whether the door 101 is opened.

At least one processor 120 may acquire the captured image by using the camera 190 if a signal indicating that the door 101 is opened is received from the door sensor.

At least one processor 120 may acquire the shelf location based on the captured image.

The shelf location may indicate the physical arrangement location of the shelf included in the electronic apparatus 100. The shelf location may indicate where the shelf is disposed in the electronic apparatus 100. The shelf location may be described as the location of the shelf, shelf identification information, or the like. The shelf identification information may include a shelf number, a shelf name, or the like.

At least one processor 120 may identify a shelf object in the captured image and identify (or specify) the shelf location based on a size information of the identified shelf object.

The shelf object may indicate an image region indicating the shelf. At least one processor 120 may identify the shelf object in the captured image based on a predetermined feature indicating the shelf.

The electronic apparatus 100 may include the plurality of shelves 10. The plurality of shelves 10 may be disposed in a vertical direction. Each of the plurality of shelves 10 may be the shelf for storing the wine. The shelf may refer to a wine rack, a wine holder, or a wine stand. A structure of the plurality of shelves is described with reference to FIG. 9.

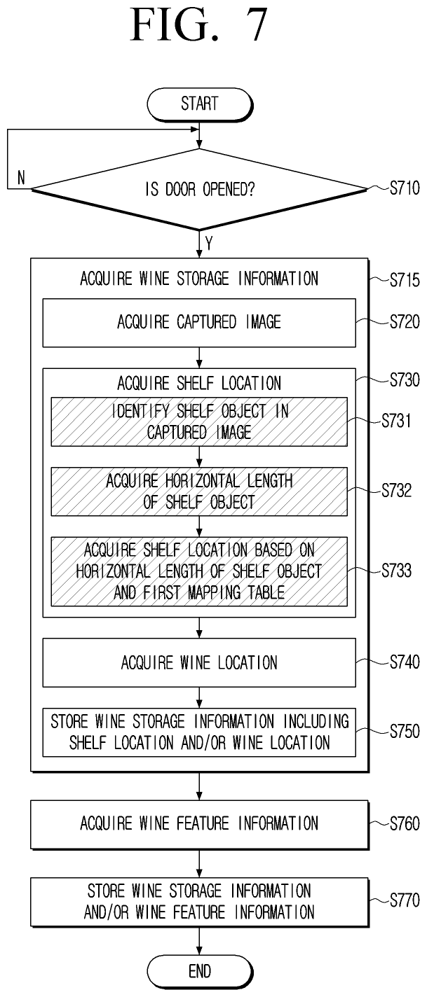

At least one processor 120 may determine which of the plurality of shelves is the shelf on which the wine is stored. At least one processor 120 may compute the shelf location by specifying the shelf on which the wine is stored. The shelf location may indicate location information indicating which of the plurality of shelves the shelf is. An operation for computing the shelf location is described with reference to FIG. 7.

At least one processor 120 may identify the shelf object in the captured image, acquire a horizontal length of the shelf object, and acquire the shelf location based on the horizontal length of the shelf object and a first mapping table stored in the memory 110. The first mapping table may include a horizontal length range corresponding to each of the plurality of shelves 10.

The shelf object may have a quadrilateral shape. The quadrilateral shape may indicate a rectangle, a square, a rhombus, a trapezoid, or the like. According to the various embodiments, the shelf object may include a partially curved shape. The shelf object may have a semicircular shape.

The horizontal length of the shelf object may indicate a length of the quadrilateral shape in a horizontal direction. The horizontal length of the shelf object may indicate its length along a predetermined first axis or in a predetermined first direction.

At least one processor 120 may acquire the shelf location from the first mapping table based on the horizontal length of the shelf object. The first mapping table may be a table indicating the shelf location corresponding to the horizontal length of the shelf object. Each of the plurality of shelves included in the electronic apparatus 100 may have a different arrangement height. The camera 190 that captures the plurality of shelves may have a fixed arrangement location.

If the camera 190 captures at least one shelf of the plurality of shelves, shelf sizes displayed (or occupied) in the captured image may be different for each shelf.

For example, it is assumed that the camera 190 is disposed at the uppermost side of the electronic apparatus 100. The shelf disposed at the uppermost layer (or location) may be displayed at a first size in the captured image. The shelf disposed at the lowermost layer (or location) may be displayed at a second size in the captured image. The farther the shelf is from the camera 190, the smaller the self may be displayed in the captured image. The first size may be larger than the second size.

At least one processor 120 may identify that the shelf location is disposed farther from the camera 190 as the horizontal length of the shelf is smaller.

At least one processor 120 may acquire first coordinate information corresponding to the shelf object based on the captured image, and acquire an outline length of the shelf object in a lowest position as the horizontal length of the shelf object based on the first coordinate information.

The first coordinate information may be information indicating coordinates at which the shelf object is identified in the captured image. The coordinate information may be described as coordinates, coordinate data, location, location information, location data, or the like. The shelf object may include a plurality of points, and the first coordinate information indicating the shelf object may thus include a plurality of coordinate values.

According to an embodiment, the first coordinate information may include information regarding the region indicating the shelf object. The shelf object may have the quadrilateral shape, and the first coordinate information indicating the shelf object may thus include the coordinate values indicating both an outline of the rectangle and an interior of the rectangle. The first coordinate information may include the coordinate values of the region indicating the shelf object.

According to an embodiment, the first coordinate information may include information regarding the outline indicating the shelf object. The shelf object may have the quadrilateral shape, and the first coordinate information indicating the shelf object may thus include the coordinate values indicating the outline of the rectangle. The first coordinate information may include the coordinate values of the outline that indicates the shelf object. The outline may be described as an edge, a boundary, the border, or the like.

At least one processor 120 may identify the outline in the lowest position among the plurality of outlines indicating the shelf object based on the first coordinate information. The shelf object may have the quadrilateral shape, and at least one processor 120 may thus identify the four outlines that indicate the shelf object. At least one processor 120 may identify the outline in the lowest position among the four outlines. The lowest position may indicate the lowest position in the captured image. If a lower left corner of the captured image is assumed as an origin, the lowest position may indicate a direction closer to an x-axis. The lowest position may indicate a direction closer to the body of the electronic apparatus 100.

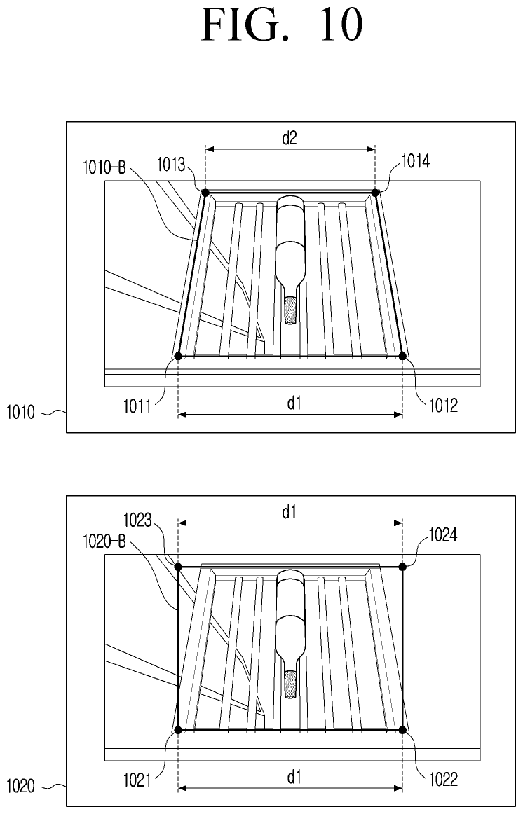

The lowest position may be described as a predetermined position, a predetermined axis, an interior position of the electronic apparatus 100, a position close to the body of the electronic apparatus 100, or the like. An operation for identifying the horizontal length of the outline in the lowest position is described with reference to FIG. 10.

At least one processor 120 may acquire (or compute) the horizontal length of the identified outline (or specified outline). At least one processor 120 may acquire the horizontal length of the outline and use the same to identify the shelf location. At least one processor 120 may compute the horizontal length of the shelf object by using various methods.

According to an embodiment, at least one processor 120 may compute the horizontal length by using a plurality of vertices indicating the shelf object. At least one processor 120 may identify the plurality of vertices corresponding to the shelf object based on the first coordinate information, identify two vertices adjacent to the camera 190 (or the body of the electronic apparatus 100) among the plurality of vertices, and acquire the outline length connecting the two vertices to each other as the horizontal length of the shelf object. A description of this configuration is provided with reference to FIG. 10.

According to an embodiment, at least one processor 120 may identify the outline having the smallest average y-axis value in the captured image among the plurality of outlines indicating the shelf object. At least one processor 120 may acquire the average y-axis value for each outline by averaging the coordinate information of the plurality of outlines. At least one processor 120 may identify the outline having the smallest value among the plurality of average y-axis values.

According to an embodiment, at least one processor 120 may identify the outline that is closest to the body of the electronic apparatus 100 among the plurality of outlines indicating the shelf object.

At least one processor 120 may identify (or specify or acquire) the shelf location based on the horizontal length of the shelf object and the first mapping table.

At least one processor 120 may identify the horizontal length range corresponding to the horizontal length among the plurality of horizontal length ranges included in the first mapping table, and identify the shelf corresponding to the identified horizontal length range as the shelf on which the wine is stored.

The first mapping table may be a table acquired considering that the shelf object displayed as being smaller if the shelf farther away from the camera 190 is captured. The first mapping table may include the horizontal length range in which each of the plurality of shelves is displayed in the captured image. At least one processor 120 may identify which of the plurality of horizontal length ranges included in the first mapping table includes the horizontal length of the shelf object that is acquired from the captured image. At least one processor 120 may identify the shelf location based on the shelf corresponding to the identified horizontal length range. The first mapping table may vary depending on a type of the electronic apparatus 100. The reason is that the heights of the plurality of shelves, the height of the camera, or the like are different depending on the type of the apparatus.

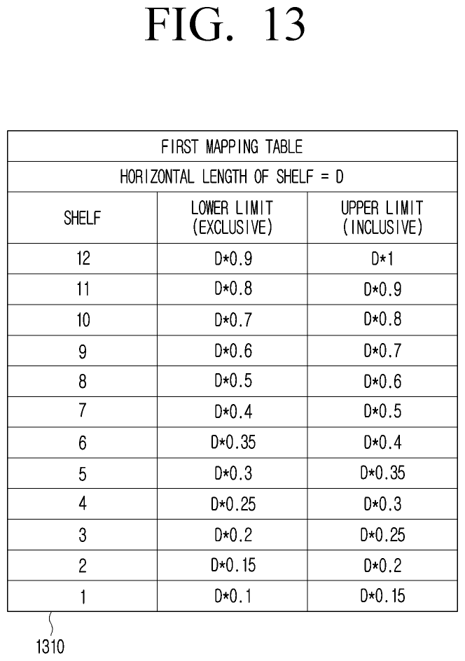

The first mapping table may be described as a first table, the horizontal length matching table, a shelf size mapping table, an image and shelf comparison table, a table for specifying the shelf, or the like. A description of the first mapping table is provided with reference to FIG. 13.

At least one processor 120 may acquire the wine location based on the captured image.

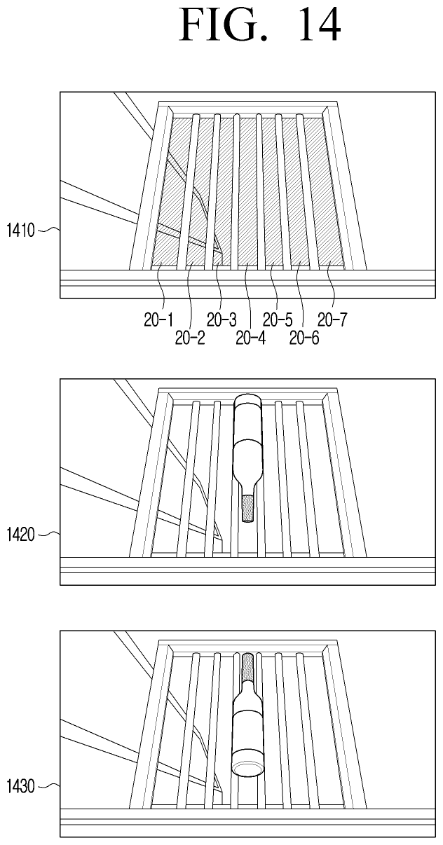

The wine location may indicate in which region the wine is placed on the shelf where the wine is placed. The wine location may be described as wine location information, wine location data, or the like. The wine location may indicate a region in which the wine is placed among the plurality of regions corresponding to the identified shelf. A description of the plurality of regions corresponding to the shelf is provided with reference to FIG. 14.

At least one processor 120 may identify the wine object in the captured image, and acquire relative location information indicating a location of the wine object in the entire region of the shelf based on the captured image.

The wine object may be an object that indicates the wine. The wine object may be an object indicating a wine bottle, a wine container, a wine cabinet, or the like. At least one processor 120 may determine whether the wine object is identified in the captured image acquired using the camera 190. To determine whether the wine object is included in the captured image, at least one processor 120 may consider the predetermined feature indicating the wine object.

If the wine object is identified, at least one processor 120 may identify the region in which the wine object is disposed among the entire region of the shelf based on the captured image. The region in which the wine object is disposed may be identified using various methods.

According to an embodiment, at least one processor 120 may identify the region in which the wine object is disposed by analyzing the captured image. The electronic apparatus 100 may pre-store the plurality of regions classified based on the coordinate values of each of the plurality of shelves. The coordinate information of the plurality of regions corresponding to the shelf may be pre-stored in the memory 110 or the like. At least one processor 120 may acquire a representative center value corresponding to the wine object. At least one processor 120 may identify a region that includes the representative center value among the coordinate information of the plurality of regions pre-stored in the memory 110. At least one processor 120 may acquire the wine location based on the identified region.

According to an embodiment, at least one processor 120 may acquire the wine location based on the relative location information of the wine object. The relative location information may indicate where the wine object is relatively disposed on the shelf. The relative location information may include a value that indicates the relative location of the wine object.

At least one processor 120 may acquire second coordinate information corresponding to the wine object based on the captured image. The second coordinate information may include a plurality of coordinate values that indicate the wine object.

The second coordinate information may be information indicating coordinates at which the wine object is identified in the captured image. The coordinate information may be described as the coordinates, the coordinate data, the location, the location information, the location data, or the like. The wine object may include the plurality of points, and the second coordinate information indicating the wine object may thus include the plurality of coordinate values.

According to an embodiment, the second coordinate information may include information regarding a region indicating the wine object. The wine object may have a cylindrical shape, and the second coordinate information indicating the wine object may thus include the coordinate values indicating both an outline of a cylinder and an interior of the cylinder. The second coordinate information may include the coordinate values of the region indicating the wine object.

According to an embodiment, the second coordinate information may include information regarding the outline indicating the wine object. The wine object may have the cylindrical shape, and the second coordinate information indicating the wine object may thus include the coordinate values indicating the outline of the cylinder. The second coordinate information may include the coordinate values of the outline indicating the wine object. The outline may be described as the edge, the boundary, the border, or the like.

At least one processor 120 may acquire the first coordinate information corresponding to the shelf object based on the captured image. At least one processor 120 may acquire the first coordinate information indicating the region including the shelf object in the entire region of the captured image.

At least one processor 120 may acquire the outline length of the shelf object in the lowest position as the horizontal length of the shelf object based on the first coordinate information.

At least one processor 120 may acquire the minimum x-axis value of the shelf object based on the first coordinate information. At least one processor 120 may acquire the minimum value among the x-axis values that indicate the shelf object in the entire region of the captured image based on the first coordinate information.

At least one processor 120 may acquire the second coordinate information corresponding to the wine object based on the captured image. At least one processor 120 may acquire the second coordinate information indicating the region including the wine object in the entire region of the captured image.

At least one processor 120 may acquire at least one of the minimum x-axis value of the wine object or the maximum x-axis value of the wine object based on the second coordinate information. At least one processor 120 may acquire the minimum value among the x-axis values that indicate the wine object based on the second coordinate information.

At least one processor 120 may acquire the relative location information corresponding to the wine object based on at least one of the minimum x-axis value of the wine object or the maximum x-axis value of the wine object, the minimum x-axis value of the shelf object, or the horizontal length of the shelf object. At least one processor 120 may acquire the wine location based on the relative location information.

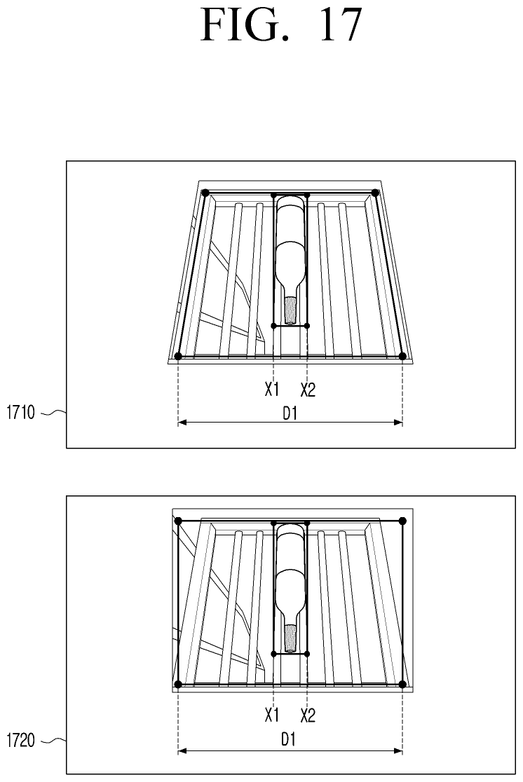

According to the various embodiments, referring to FIG. 17, the relative location information may be computed by separating the region indicating the shelf object. At least one processor 120 may separate and compute only the region indicating the shelf object to compute a value related to the x-axis. At least one processor 120 may compute the values related to the x-axis based on the first coordinate information indicating the region related to the shelf object. In case of computing the relative location information by separating the region indicating the shelf object, at least one processor 120 may compute the minimum x-axis value of the shelf object as 0, and compute the minimum x-axis value of the wine object or the maximum x-axis value of the wine object based on the region indicated by the first coordinate information.

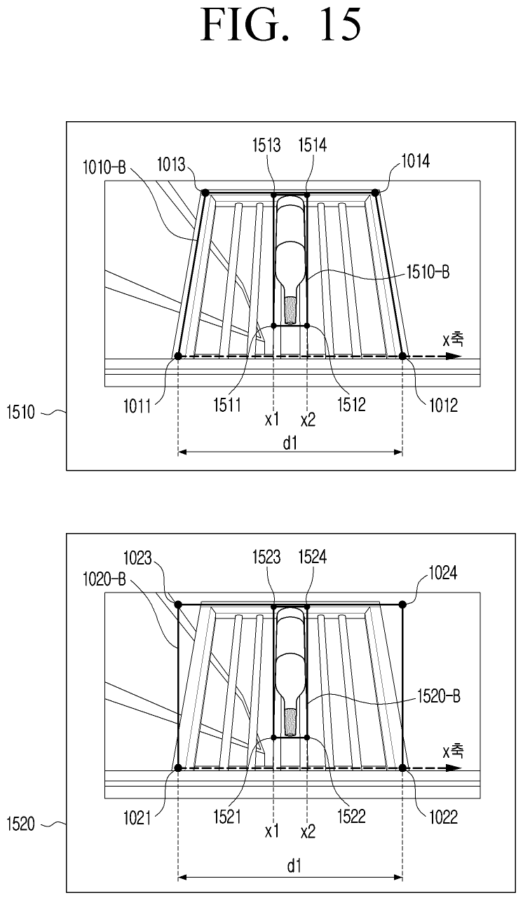

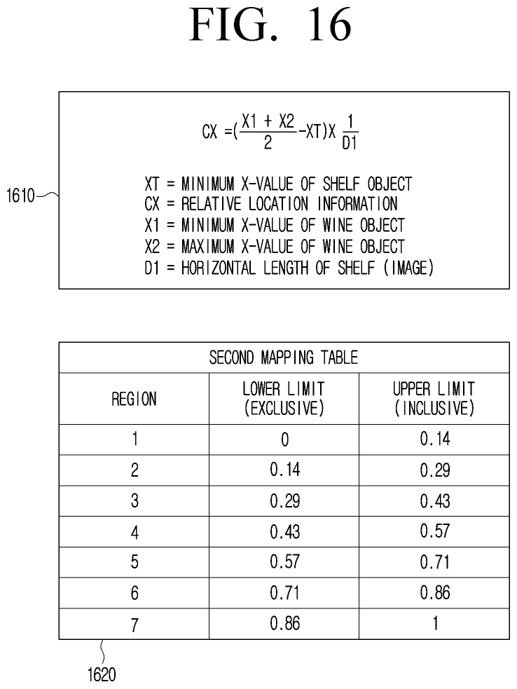

The minimum x-axis value of the wine object, the maximum x-axis value of the wine object, the minimum x-axis value of the shelf object, the horizontal length of the shelf object, or the like is described with reference to FIG. 15. A process of computing the relative location information is described with reference to FIG. 16.

At least one processor 120 may acquire the wine location based on the relative location information and a second mapping table stored in the memory 110. The second mapping table may include a relative location range corresponding to each of the plurality of regions of the shelf.

The second mapping table may include the relative location range corresponding to each of the plurality of regions corresponding to the shelf.

The second mapping table may vary depending on a type of the shelf. The same second mapping table may be used if the shelf has the same structure. The shelf having a different structure may use a different second mapping table. The second mapping table is described with reference to FIG. 16.

The structure of the shelf may indicate the structure of the shelf itself. For example, seven regions (or storage regions) may be present based on the structure of the shelf described in reference numeral 1410 of FIG. 14.

At least one processor 120 may acquire the wine feature information corresponding to the wine. At least one processor 120 may identify the wine object based on the captured image and acquire the wine feature information corresponding to the identified wine object.

The wine feature information may include information indicating a wine feature. The wine feature information may include descriptive information regarding the wine being stored. The wine feature information may include various information related to the wine.

The wine feature information may include at least one of the name, type, flavor, manufacturer, manufacturing date, expiration date, price, or rating of the wine. The wine feature information is not limited thereto, and may include various additional information indicating the wine.

At least one processor 120 may acquire the wine feature information through various routes.

According to an embodiment, at least one processor 120 may acquire the wine feature information from the electronic apparatus 100 itself. The electronic apparatus 100 may store the wine feature information corresponding to the plurality of wines in the memory 110 or the like. At least one processor 120 may acquire (or identify) the wine feature information corresponding to the identified wine object based on the captured image among the plurality of wine feature information stored in the memory 110.

According to an embodiment, at least one processor 120 may acquire the wine feature information from the server 200. The server 200 may include a database that stores the wine feature information corresponding to each of the plurality of wines. The server 200 may be described as an external server.

At least one processor 120 may be connected to the server 200 through a communication interface 130 included in the electronic apparatus 100. At least one processor 120 may transmit the information to or receive the information from the server 200 through the communication interface 130.

At least one processor 120 may use various input data to acquire the wine feature information.

According to an embodiment, at least one processor 120 may acquire the wine feature information by using an original captured image. At least one processor 120 may identify the wine object based on the captured image, and acquire the wine feature information based on the region corresponding to the identified wine object.

According to an embodiment, at least one processor 120 may identify the wine object based on the captured image, and acquire the wine image by separating (or extracting or cropping) only the region including the wine object. The wine image may indicate separate image data that includes only the wine object. At least one processor 120 may acquire the wine feature information based on the wine image.

According to an embodiment, at least one processor 120 may acquire the wine feature information by using a pre-stored wine sample image. At least one processor 120 may store the wine sample image in the database through a wine registration process, acquire the wine sample image corresponding to the wine object if the wine object is identified in the captured image, and acquire the wine feature information based on the wine sample image.

The wine registration process may include a process of acquiring the captured image including the wine object having a threshold size or more by using the camera 190 included in the electronic apparatus 100. The camera 190 has the fixed location, and the captured image acquired by at least one processor 120 through the camera 190 may thus have the same resolution. A size of the wine object included in the captured image may vary depending on a location where the wine is captured.

For example, the captured image acquired by capturing the wine at a close distance from the camera 190 may include the wine object of the threshold size or more. The captured image acquired by capturing the wine at a far distance from the camera 190 may include the wine object less than the threshold size.

In the wine registration process, at least one processor 120 may identify the size of the wine object from the acquired captured image. At least one processor 120 may identify whether the size of the wine object is a threshold value or more. At least one processor 120 may acquire the coordinate information of the wine object from the captured image and determine the size of the wine object based on the coordinate information.

The size of the wine object may include at least one of the vertical length, horizontal length, diagonal length, and area of the wine object. At least one processor 120 may store the captured image as the wine sample image in the database if the size of the wine object is the threshold value or more. The database may indicate a separate storage space (or region) in the memory 110 that stores only the wine sample images.

At least one processor 120 may provide a guide user interface (UI) to request a recapture of the wine if the size of the wine object is less than the threshold value. The guide UI may include at least one of information indicating that the size of the wine object is small, information guiding to capture the wine closer to the camera 190, or information guiding to input a recapture command.

Through the guide UI, the user may perform a capture for the registration while moving the wine closer to the camera 190. The user may store the wine sample image including the wine object of the threshold size or more through the guide UI.

According to the various embodiments, the wine registration process may include a process of registering the captured image that is captured using the camera included in a user terminal 300. The user may capture the wine within a threshold distance by using the user terminal 300, and store the image captured within the threshold distance as the wine sample image in the database.

The camera 190 of the electronic apparatus 100 may acquire a first camera that acquires the captured image based on a first resolution, and a second camera that acquires the captured image based on a second resolution smaller than the first resolution.

In the wine registration process, at least one processor 120 may acquire the wine sample image by using the first camera.

In a wine storage process, at least one processor 120 may acquire the captured image by using the second camera.

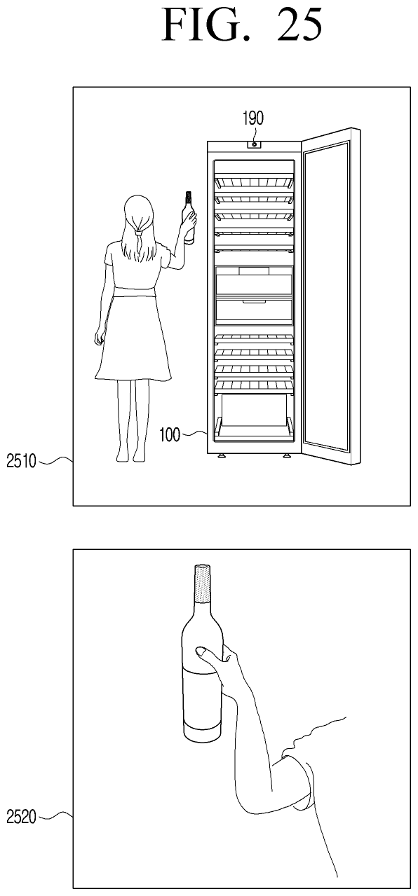

The wine sample image acquired using the first camera may include the wine object displayed larger than in the image captured by using the second camera. A description of the wine registration process is provided with reference to FIGS. 25 to 27.

At least one processor 120 may identify whether the wine feature information is acquired based on the various input data. At least one processor 120 may not acquire the wine feature information if the size of the wine object included in the input data (e.g., wine image) is excessively small or the wine object is not accurately identified. At least one processor 120 may not acquire the wine feature information if the wine is new wine that is not stored in the database corresponding to the wine.

At least one processor 120 may provide the guide UI for acquiring the wine feature information if an event occurs where the wine feature information is unable to be acquired. The guide UI may include guide information for inputting the wine feature information.

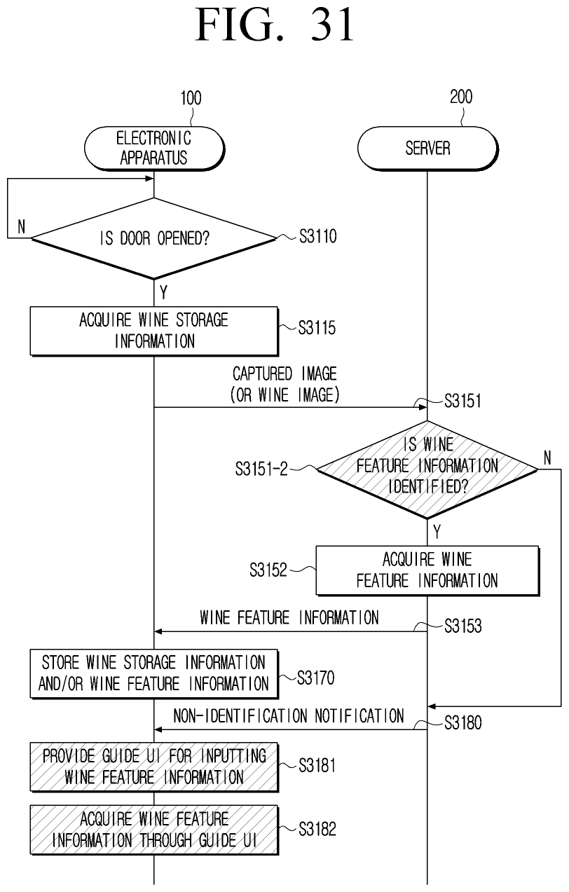

The guide UI may be provided on the electronic apparatus 100. A description of this configuration is provided with reference to FIG. 31.

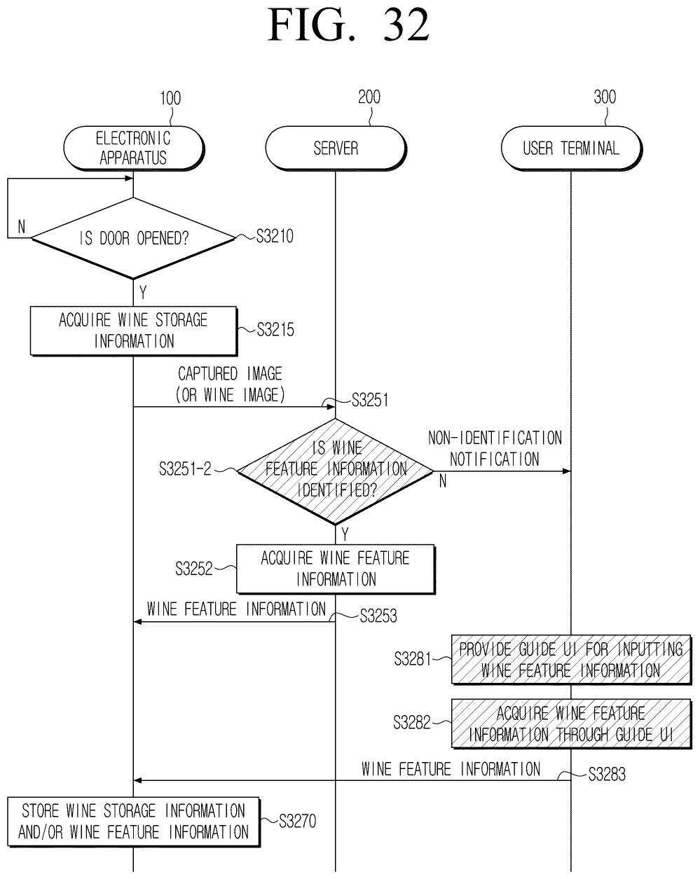

The guide UI may be provided on the user terminal 300. A description of this configuration is provided with reference to FIG. 32.

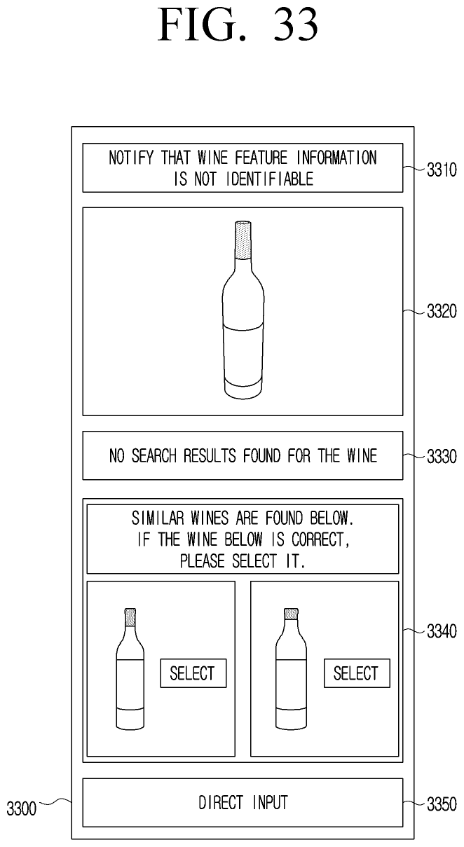

A description of the guide UI is provided with reference to FIG. 33.

At least one processor 120 may acquire the wine storage information including the shelf location and the wine location, and acquire the wine feature information corresponding to stored wine. At least one processor 120 may acquire the wine information including the wine storage information and the wine feature information, and store the wine information in the memory 110.

At least one processor 120 may provide the information on the stored wine to the user. The information may be provided to the user by using the various methods.

According to an embodiment, the electronic apparatus 100 may provide the wine information to the user by executing an application included in the electronic apparatus 100. The application may generate and provide a screen indicating a wine storage state.

The electronic apparatus 100 may include a display 140. The electronic apparatus 100 may display the wine information on the display 140. The electronic apparatus 100 may display a screen provided by the wine application including the wine information on the display 140.

According to an embodiment, the electronic apparatus 100 may transmit the information on the stored wine to the user terminal 300 of the user. The user terminal 300 may receive the wine information from the electronic apparatus 100. The wine information may be provided to the user through the wine application installed on the user terminal 300. The screen related to the wine application for providing the wine information may be displayed through a display included in the user terminal 300.

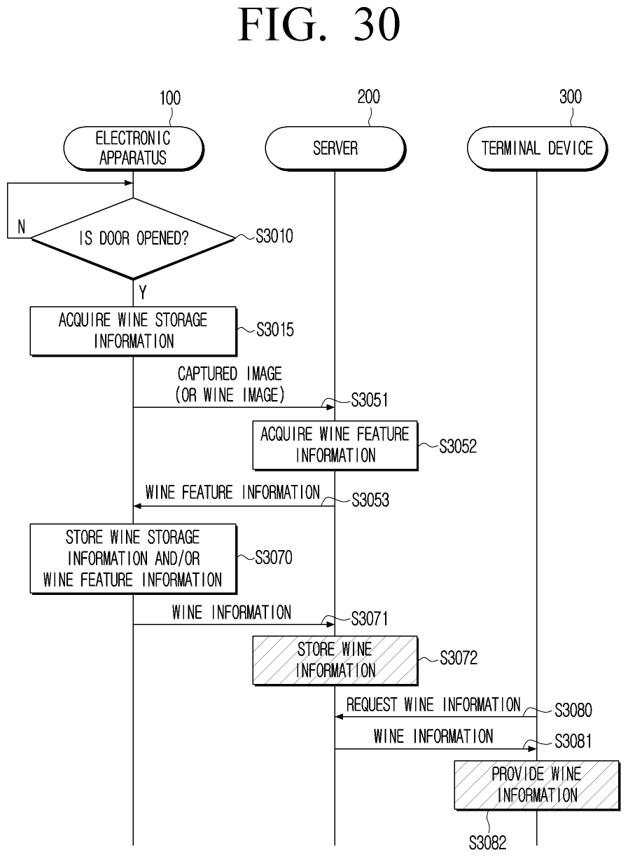

According to an embodiment, the electronic apparatus 100 may transmit the information on the stored wine to the external server. The external server may be an internet of things (IoT) server. The external server may be connected to at least one home appliance (or smart home appliance). The external server may transmit various control instructions to at least one home appliance connected to the external server. The external server may receive various information from at least one home appliance. The external server may be connected to the user terminal 300. The external server may provide the wine information in response to a request from the user terminal 300. A description of this configuration is provided with reference to FIG. 30.

The electronic apparatus 100 may provide a location of the shelf on which the wine is stored and the wine location on the shelf in case of storing the wine. The location related to the wine storage and the wine information may be automatically stored together even if the user does not launch an application to directly input the wine information. The user may receive the wine storage information and the wine feature information without any separate action.

The electronic apparatus 100 may provide various services by using the wine feature information.

According to an embodiment, the electronic apparatus 100 may provide the optimal temperature corresponding to the wine based on the wine feature information after acquiring the wine feature information. The optimal temperature corresponding to the wine feature information may be different for each wine. The electronic apparatus 100 may perform the refrigeration function by identifying the optimal temperature corresponding to the wine based on the wine feature information and setting the identified optimal temperature.

According to an embodiment, the electronic apparatus 100 may provide recommended food information corresponding to the wine feature information after acquiring the wine feature information. The electronic apparatus 100 may identify recommended food corresponding to the wine feature information and provide the recommended food to the user. A time point of acquiring the wine feature information may be a time point of storing the wine. The electronic apparatus 100 may identify whether an event occurs in which the user takes out the stored wine. If the event occurs in which the user takes out the stored wine, the electronic apparatus 100 may acquire the wine feature information of the wine corresponding to the occurrence of the event. The electronic apparatus 100 may identify the recommended food information corresponding to the wine feature information and provide the recommended food information to the user. The recommended food information corresponding to the wine feature information may be pre-stored in advance.

According to an embodiment, the electronic apparatus 100 may guide (or recommend) the wine storage location by comparing all the wines stored on the shelf after acquiring the wine feature information. The storage temperature may vary depending on the wine. For wine management, wines having similar storage temperatures may be stored on the same shelf. The electronic apparatus 100 may identify the optimal temperature corresponding to the wine based on the wine feature information.

The electronic apparatus 100 may compare the optimal temperature of the already stored wine with the optimal temperature of the newly stored wine. The electronic apparatus 100 may guide a location of the newly stored wine to be moved to the shelf on which the already stored wine is placed if a difference between the optimal temperature of the already stored wine and the optimal temperature of the newly stored wine is less than the threshold value.

The already stored wine is described as first wine, and the first wine is assumed to be stored in a first region of a first shelf. It is assumed that an event occurs in which second wine is newly stored, and a difference between the optimal temperature of the first wine and the optimal temperature of the second wine is less than the threshold value. The electronic apparatus 100 may provide information (or a screen) guiding the storage of the second wine in a second region of the first shelf on which the first wine is stored after the wine feature information of the second wine is acquired.

The electronic apparatus 100 may update the wine storage location. If the door is opened, the electronic apparatus 100 may identify whether the location of the stored wine is changed. The electronic apparatus 100 may update existing storage information (storage location information of all the stored wines) by using the acquired wine storage information if an event is identified in which the location of the stored wine is changed. The electronic apparatus 100 may only update the location (or region) where the wine location is changed.

The electronic apparatus 100 may identify an event in which the wine location is changed. The electronic apparatus 100 may track the wine location in real time by using the camera 190. The electronic apparatus 100 may identify whether the wine is continuously identified in the plurality of captured images acquired using the camera 190.

The electronic apparatus 100 may use the wine feature information corresponding to wine stored in a first location as it is if an event is identified in which the wine is continuously identified and moved from the first location to a second location. The wine may only be moved from the first location to the second location, and the electronic apparatus 100 may thus use the wine feature information stored together with the wine storage information including the first location as it is. The electronic apparatus 100 may store the wine feature information together with the wine storage information including the second location.

The electronic apparatus 100 may provide a notification to the user if an event is identified in which the wine is discontinuously identified and moved from the first location to the second location. The fact that the wine is discontinuously identified may indicate that the wine object is not identified in some of the captured images that are acquired continuously. For example, a situation may occur where the user starts taking out the wine within a field of view of the camera 190, moves the wine out of the field of view, and then moves the wine back into the field of view after a predetermined time. The user may take out the wine from the first location, move the wine out of the field of view of the camera 190, and then place the wine back in the second location.

The electronic apparatus 100 may acquire a time during which the wine object is not acquired in the captured image. The time during which the wine object is not acquired in the captured image may be described as a wine non-detection time.

The electronic apparatus 100 may provide first notification information if the wine non-detection time is less than or equal to a first threshold time. The first notification information may include voice feedback. The first notification information may include a guide instruction requesting the user to touch the wine once if the wine is the new wine.

The electronic apparatus 100 may provide the guide UI to the user terminal 300 if the wine non-detection time is more than the first threshold time and is less than or equal to a second threshold time. The guide UI may include information querying whether the wine newly recognized in the second location is the wine taken out from the existing first location or the new wine. The second threshold time may be greater than the first threshold time.

The electronic apparatus 100 may determine whether wine stored in the second location is the existing wine or the new wine based on the user input received through the guide UI. The electronic apparatus 100 may use the wine feature information of the wine stored in the first location as it is if the wine stored in the second location is the existing wine. The electronic apparatus 100 may acquire the new wine feature information based on the wine image of the wine stored in the second location if the wine stored in the second location is the new wine.

The electronic apparatus 100 may determine that the wine stored in the second location is the new wine rather than the existing wine if the wine non-detection time is more than the second threshold time. The electronic apparatus 100 may acquire the new wine feature information based on the wine image of the wine stored in the second location.

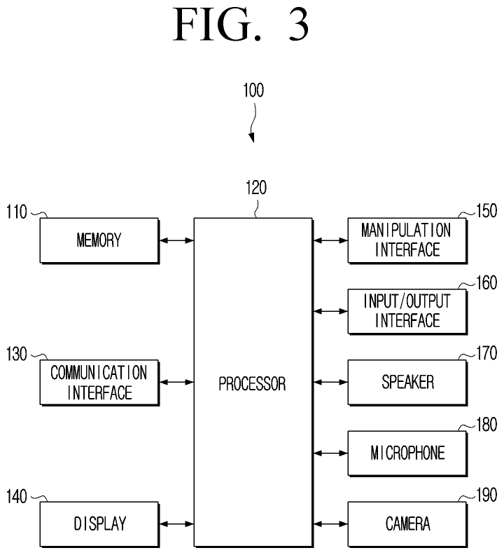

FIG. 3 is a block diagram for describing a configuration of the electronic apparatus 100 in FIG. 2 according to an embodiment.

Referring to FIG. 3, the electronic apparatus 100 may include at least one of the memory 110, at least one processor 120, the communication interface 130, the display 140, a manipulation interface 150, an input/output interface 160, a speaker 170, a microphone 180, or the camera 190.

The memory 110 may be implemented as an internal memory such as a read-only memory (ROM, e.g., electrically erasable programmable read-only memory (EEPROM)) or a random access memory (RAM), included in at least one processor 120, or as a memory separate from at least one processor 120. The memory 110 may be implemented in the form of a memory embedded in the electronic apparatus 100 or in the form of a memory detachable from the electronic apparatus 100, based on a data storage purpose. For example, data for driving the electronic apparatus 100 may be stored in the memory embedded in the electronic apparatus 100, and data for an extension function of the electronic apparatus 100 may be stored in the memory detachable from the electronic apparatus 100.

The memory embedded in the electronic apparatus 100 may be implemented as at least one of a volatile memory (e.g., dynamic RAM (DRAM), static RAM (SRAM) or synchronous dynamic RAM (SDRAM)) or a non-volatile memory (e.g., one time programmable ROM (OTPROM), programmable ROM (PROM), erasable and programmable ROM (EPROM), electrically erasable and programmable ROM (EEPROM), a mask ROM, a flash ROM, a flash memory (e.g., NAND flash or NOR flash), a hard drive, or a solid state drive (SSD)); and the memory detachable from the electronic apparatus 100 may be implemented as a memory card (e.g., compact flash (CF), secure digital (SD), micro secure digital (Micro-SD), mini secure digital (mini-SD), extreme digital (xD), or multi-media card (MMC)), an external memory which is capable of being connected to a universal serial bus (USB) port (e.g., USB memory), or the like.

The memory 110 may store at least one instruction. At least one processor 120 may perform various operations based on the instruction stored in the memory 110.

At least one processor 120 may be implemented as a digital signal processor (DSP), a microprocessor, or a time controller (TCON), which processes a digital signal. The processor 120 is not limited thereto, and may include at least one of a central processing unit (CPU), a micro controller unit (MCU), a micro processing unit (MPU), a controller, an application processor (AP), a graphics-processing unit (GPU), a communication processor (CP), or an advanced reduced instruction set computer (RISC) machine (ARM) processor, or may be defined by these terms. At least one processor 120 may be implemented as a system-on-chip (SoC) or a large scale integration (LSI), in which a processing algorithm is embedded, or may be implemented in the form of a field programmable gate array (FPGA). The processor 120 may perform various functions by executing computer executable instructions stored in the memory.

The communication interface 130 may be a component that communicates with the various types of external devices by using various types of communication methods. The communication interface 130 may include a wireless communication module or a wired communication module. Each communication module may be implemented in the form of at least one hardware chip.

The wireless communication module may be a module that communicates with the external device in a wireless manner. For example, the wireless communication module may include at least one of a wireless-fidelity (Wi-Fi) module, a Bluetooth module, an infrared communication module, or another communication module.

The Wi-Fi module and the Bluetooth module may respectively perform the communication in a Wi-Fi manner and a Bluetooth manner. In case of using the Wi-Fi module or the Bluetooth module, it may first transmit and receive various connection information such as a service set identifier (SSID) or a session key, connect the communication by using this connection information, and then transmit and receive various information.

The infrared communication module may perform the communication based on infrared data association (IrDA) technology of transmitting data in the wireless manner in a short distance by using an infrared ray between visible and millimeter waves.

In addition to the above-described communication manners, another communication module may include at least one communication chip for performing the communication on the basis of various wireless communication standards such as zigbee, third generation (3G), third generation partnership project (3GPP), long term evolution (LTE), LTE advanced (LTE-A), fourth generation (4G), and fifth generation (5G).

The wired communication module may be a module that communicates with the external device in a wired manner. For example, the wired communication module may include at least one of a local area network (LAN) module, an Ethernet module, a pair cable, a coaxial cable, an optical fiber cable, or an ultra wide-band (UWB) module.

According to the various embodiments, the communication interface 130 may use the same communication module (e.g., Wi-Fi module) to communicate with the external device and the external server, such as a remote control apparatus.

According to the various embodiments, the communication interface 130 may use the different communication modules to communicate with the external device and the external server, such as the remote control apparatus. For example, the communication interface 130 may use at least one of the Ethernet module or the Wi-Fi module to communicate with the external server, and may use the Bluetooth module to communicate with the external device such as the remote control apparatus. However, this case is only an embodiment, and the communication interface 130 may use at least one communication module among various communication modules in case of communicating with the plurality of external devices or external servers.

The display 140 may be implemented as various types of displays such as a liquid crystal display (LCD), an organic light emitting diode (OLED) display, or a plasma display panel (PDP). The display 140 may include a driving circuit, a backlight unit, and the like, which may be implemented in a form such as an amorphous silicon thin film transistor (a-si TFT), a low temperature poly silicon (LTPS) TFT, or an organic TFT (OTFT). The display 140 may be implemented as a touch screen coupled with a touch sensor, a flexible display, a three-dimensional (3D) display, or the like. The display 140 according to an embodiment of the present disclosure may include not only a display panel outputting an image, but also a bezel housing the display panel. The bezel may include the touch sensor for detecting user interaction according to an embodiment of the present disclosure.

The manipulation interface 150 may be implemented as a device such as a button, a touch pad, a mouse, or a keyboard, or may be implemented as a touch screen capable of also performing a manipulation input function in addition to the above-described display function. The button may be any of various types of buttons such as a mechanical button, a touch pad, or a wheel, which is disposed in any region, such as the front surface portion, side surface portion, or rear surface portion of a body appearance of the electronic apparatus 100.

The input/output interface 160 may be any of a high definition multimedia interface (HDMI), a mobile high-definition link (MHL), a universal serial bus (USB), a display port (DP), a thunderbolt, a video graphics array (VGA) port, a red-green-blue (RGB) port, a D-subminiature (D-SUB), or a digital visual interface (DVI). The input/output interface 160 may input/output at least one of an audio signal or a video signal. According to an implementation example, the input/output interface 160 may include a port for inputting and outputting only the audio signal and a port for inputting and outputting only the video signal as its separate ports, or may be implemented as a single port for inputting and outputting both the audio signal and the video signal. The electronic apparatus 100 may transmit at least one of the audio signal or the video signal to the external device (e.g., external display device or external speaker) through the input/output interface 160. The output port included in the input/output interface 160 may be connected to the external device, and the electronic apparatus 100 may transmit at least one of the audio signal or the video signal to the external device through the output port.

The input/output interface 160 may be connected with the communication interface. The input/output interface 160 may transmit information received from an external machine to the communication interface, or transmit information received through the communication interface to the external machine.

The speaker 170 may be a component that outputs not only various audio data but also various notification sounds, voice messages, or the like.

The microphone 180 is a component that receives a user voice or other sounds to convert the same into the audio data. The microphone 180 may receive the user voice while activated. For example, the microphone 180 may be integrated with the electronic apparatus 100 in its upper, front, or side direction. The microphone 118 may include various components such as a microphone collecting the user voice in an analog form, an amplifier circuit amplifying the collected user voice, an analog to digital (A/D) conversion circuit sampling the amplified user voice and converting the same to the digital signal, and a filter circuit removing a noise component from the converted digital signal.

The camera 190 may be a component that captures the subject and generates the captured image, and the captured image may indicate a concept including both a moving image and a still image. The camera 190 may acquire an image for at least one external machine, and may be implemented as the camera, a lens, an infrared sensor, or the like.

The camera 190 may include the lens and the image sensor. A type of lenses may include a multi-purpose lens, a wide-angle lens, or a zoom lens, and may be determined based on the type, feature, usage environment, and the like of the electronic apparatus 100. The image sensor may use a complementary metal oxide semiconductor (CMOS), a charge coupled device (CCD), or the like.

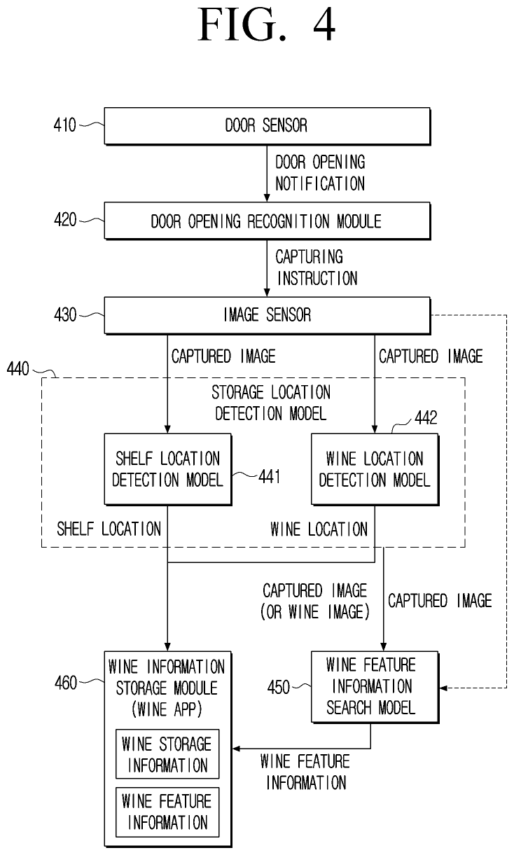

FIG. 4 is a diagram for describing an operation of storing the wine information according to an embodiment.

Referring to FIG. 4, the electronic apparatus 100 may include at least one of a door sensor 410, a door opening recognition module 420, an image sensor 430, a storage location detection model 440, a wine feature information search model 450, or a wine information storage module 460.

The door sensor 410 may sense whether the door attached to the electronic apparatus 100 is opened or closed.

According to an embodiment, the door sensor 410 may generate a first signal if the door is opened. The electronic apparatus 100 may identify that the door is opened only if the first signal is received. The electronic apparatus 100 may identify that the door is closed if the first signal is not received.

The door sensor 410 may acquire the sensing data. The electronic apparatus 100 may identify whether the door is opened or closed based on the sensing data.

According to an embodiment, the door sensor 410 may generate the first signal if the door is opened and generate a second signal if the door is closed. The electronic apparatus 100 may identify that the door is opened if the first signal is received. The electronic apparatus 100 may identify that the door is closed if the second signal is received.

If the door is opened, the door sensor 410 may transmit a door opening notification (or first signal) indicating that the door is opened to the door opening recognition module 420. The door opening recognition module 420 may transmit a capturing instruction to the image sensor 430 if the door opening notification is received.

The image sensor 430 may include the camera 190. The image sensor 430 may acquire the sensing data if the capturing instruction is received. The sensing data may include the captured image. The captured image may be an image acquired by capturing the front surface of the electronic apparatus 100. The image sensor 430 may be disposed toward the front surface (surface where the door is capable of being opened) of the electronic apparatus 100. The description of the captured image is already provided with reference to FIG. 1.

The captured image acquired through the image sensor 430 may be transmitted to the storage location detection model 440. The electronic apparatus 100 may transmit the captured image to the storage location detection model 440.

The storage location detection model 440 may include at least one of a shelf location detection model 441 or a wine location detection model 442. The storage location detection model 440 may include information related to the wine storage.

The shelf location detection model 441 may acquire the shelf location (or shelf location information) that indicates which of the plurality of shelves the wine is stored on. The shelf location detection model 441 may transmit the shelf location to the wine information storage module 460. A description of the shelf location is provided with reference to FIGS. 9 to 13.

The wine location detection model 442 may acquire the wine location (or wine location information) that indicates where on a shelf the wine is placed. The wine location detection model 442 may transmit the wine location to the wine information storage module 460. A description of the wine location is provided with reference to FIGS. 14 to 18.

The electronic apparatus 100 may acquire the shelf location by using the shelf location detection model 441 and acquire the wine location by using the wine location detection model 442.

The electronic apparatus 100 may transmit the captured image or the wine object region to the wine feature information search model 450.

According to an embodiment, the electronic apparatus 100 may transmit the captured image including the wine object to the wine feature information search model 450. The captured image may include the shelf object and the wine object.

According to an embodiment, the electronic apparatus 100 may extract (or crop) the image region that includes only the wine object from the captured image. The electronic apparatus 100 may transmit data on the image region that includes only the wine object to the wine feature information search model 450. The data on the image region that includes only the wine object may be described as the wine image.

The wine feature information search model 450 may receive the captured image or the wine image by using various methods.

According to an embodiment, the storage location detection model 440 may transmit the received captured image (or wine image) to the wine feature information search model 450.

According to an embodiment, the wine location detection model 442 may transmit the received captured image (or wine image) to the wine feature information search model 450. The wine location detection model 442 may analyze the wine location in the captured image. The wine location detection model 442 may acquire the wine image to analyze the wine location, and transmit the wine image to the wine feature information search model 450.

According to an embodiment, the image sensor 430 may transmit the captured image to the wine feature information search model 450.

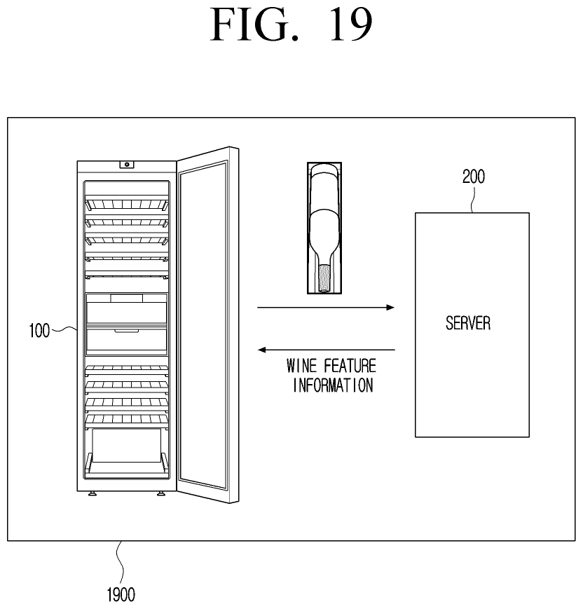

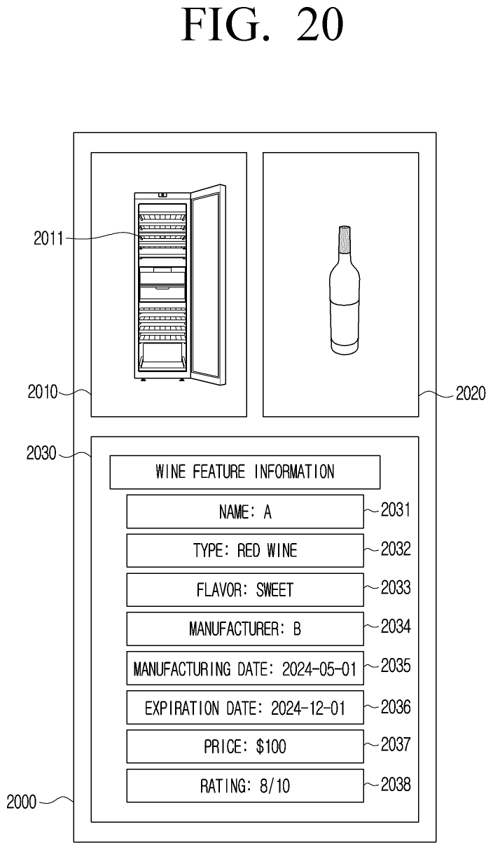

The wine feature information search model 450 may receive the captured image or the wine image. The wine feature information search model 450 may analyze the wine feature based on the captured image or the wine image. The wine feature information search model 450 may acquire the wine feature information. The wine feature information may include various information on the wine itself. The wine feature information search model 450 may transmit the wine feature information to the wine information storage module 460. A description of the wine feature information is provided with reference to FIGS. 19 and 20.

The wine information storage module 460 may be a module that stores the various information related to the wine. The wine information storage module 460 may be a module corresponding to the wine application. The wine information storage module 460 may store the wine information. The wine information may include at least one of the wine storage information indicating the location where the wine is stored or the wine feature information related to the wine feature. The wine storage information may include at least one of the shelf location or the wine location.

The wine information storage module 460 may receive the shelf location from the shelf location detection model 441. The wine information storage module 460 may receive the wine location from the wine location detection model 442. The wine information storage module 460 may receive the wine feature information from the wine feature information search model 450.

The wine information storage module 460 may provide the wine information (at least one of the wine storage information or the wine feature information) based on a predetermined control instruction.

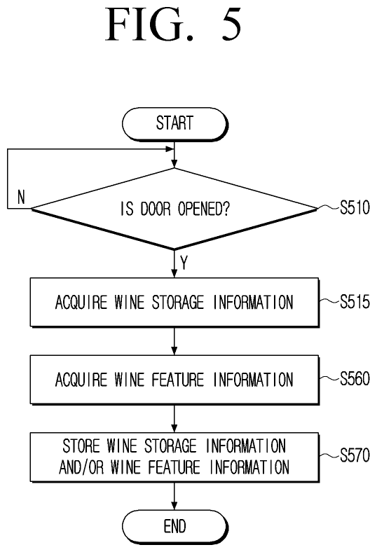

FIG. 5 is a diagram for describing an operation of acquiring the wine storage information or the wine feature information according to an embodiment.

Referring to FIG. 5, the electronic apparatus 100 may identify whether the door is opened (S510). The electronic apparatus 100 may repeatedly perform step S510 until the door is opened if the door is not opened (S510-N).

The electronic apparatus 100 may acquire the wine storage information (S515) if the door is opened (S510-Y). The wine storage information may include the information related to the wine storage. The wine storage information may include at least one of the shelf location indicating information related to the shelf on which the wine is placed, or the wine location indicating in which region of the shelf the wine is placed.

The electronic apparatus 100 may acquire the wine feature information (S560). The wine feature information may indicate various information related to the wine feature. The wine feature information may include at least one of the name, type, flavor, manufacturer, manufacturing date, expiration date, price, or rating of the wine.

The wine feature information may vary for each wine. Even wines having the same name produced by the same manufacturer may differ in terms of the manufacturing date or the expiration date.

The electronic apparatus 100 may store the wine information including at least one of the wine storage information or the wine feature information (S570).

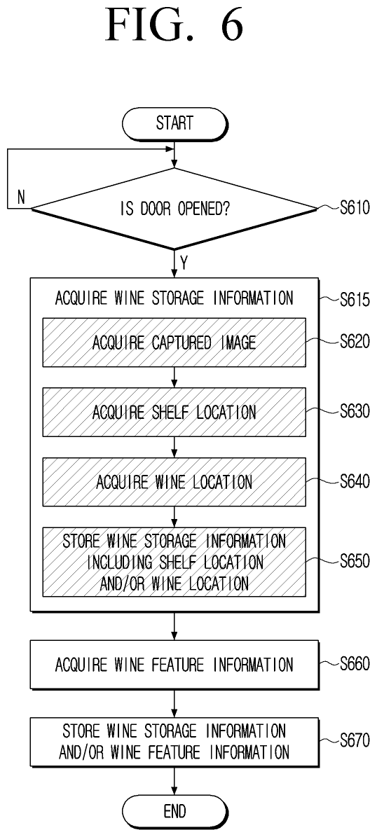

FIG. 6 is a diagram for describing an operation of acquiring the wine storage information according to an embodiment.

Steps S610, S615, S660, and S670 of FIG. 6 may correspond to steps S510, S515, S560, and S570 of FIG. 5.

The electronic apparatus 100 may acquire the captured image (S620) if the door opening is identified (S610-Y). The electronic apparatus 100 may acquire the shelf location in the captured image (S630). The shelf location may be determined based on a location of the shelf object. The electronic apparatus 100 may acquire the coordinate information of the shelf object and specify which shelf object is one of the plurality of shelves based on the coordinate information of the shelf object.

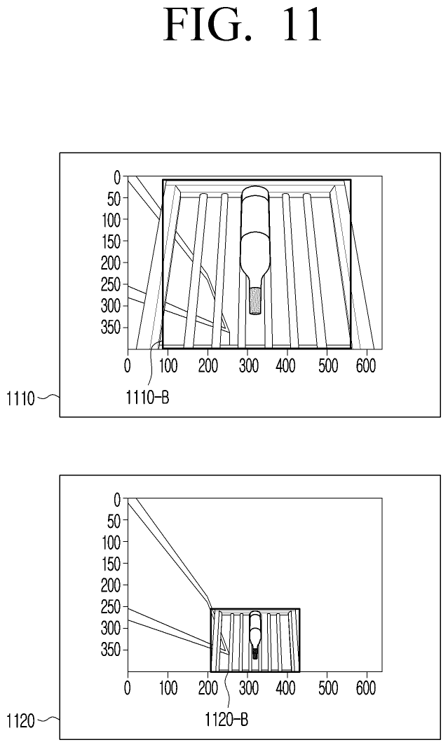

For example, the electronic apparatus 100 may acquire the shelf location based on the horizontal length of the shelf object included in the captured image. It is assumed that the shelf is classified into a plurality of layers. The shelf disposed on a relatively high layer may be displayed larger in the captured image. The shelf disposed on a relatively low layer may be displayed smaller in the captured image. A description of this configuration is provided with reference to FIG. 11.

The electronic apparatus 100 may acquire the wine location based on the captured image (S640). The electronic apparatus 100 may identify which region in the entire region of the shelf the wine is placed. The wine location may indicate the region (or location) in which the wine is placed on the shelf.

The electronic apparatus 100 may store the wine storage information including at least one of the shelf location or the wine location (S650).

FIG. 7 is a diagram for describing an operation of acquiring the shelf location according to an embodiment.

Referring to FIG. 7, steps S710, S715, S760, and S770 may correspond to steps S510, S515, S560, and S570 of FIG. 5. Steps S710, S715, S720, S730, S740, S750, S760, and S770 may correspond to steps S610, S615, S620, S630, S640, S650, S660, and S670 of FIG. 6.

The electronic apparatus 100 may identify the shelf object in the captured image (S731). The electronic apparatus 100 may acquire the horizontal length of the shelf object (S732).

The electronic apparatus 100 may acquire the shelf location based on the horizontal length of the shelf object and the first mapping table (S733). The first mapping table may be a table indicating the shelf location corresponding to the horizontal length. The first mapping table may be a mapping table for indicating the shelf location based on the horizontal length of the shelf object. The first mapping table may include a length range corresponding to each of the plurality of shelve locations. The electronic apparatus 100 may identify the shelf as a shelf corresponding to a length range if the horizontal length of the shelf object is included in the length range. A description of the first mapping table is provided with reference to FIG. 13.

According to an embodiment, the electronic apparatus 100 may identify the shelf object on which the wine is placed. The electronic apparatus 100 may identify whether both the shelf object and the wine object are recognized in the captured image. The electronic apparatus 100 may identify the shelf object on which the wine object is placed if both the shelf object and the wine object are identified.

According to an embodiment, the electronic apparatus 100 may determine whether the shelf object on which the wine object is placed is identified if the wine object is identified.

According to an embodiment, the electronic apparatus 100 may determine whether to acquire the shelf location by comparing the horizontal length of the shelf object with its vertical length. The electronic apparatus 100 may compare the horizontal length of the shelf object with its vertical length in real time by acquiring the captured image in real time. The electronic apparatus 100 may identify a bounding box based on the coordinate information indicating the shelf object. The electronic apparatus 100 may acquire horizontal and vertical lengths of the bounding box indicating the shelf object.

The electronic apparatus 100 may not perform a computation operation to acquire the shelf location if a value (or ratio) of the vertical length divided by the horizontal length is less than or equal to the threshold value (e.g., 0.5). The electronic apparatus 100 may perform the computation operation to acquire the shelf location if the value (or ratio) of the vertical length divided by the horizontal length is more than the threshold value (e.g., 0.5).

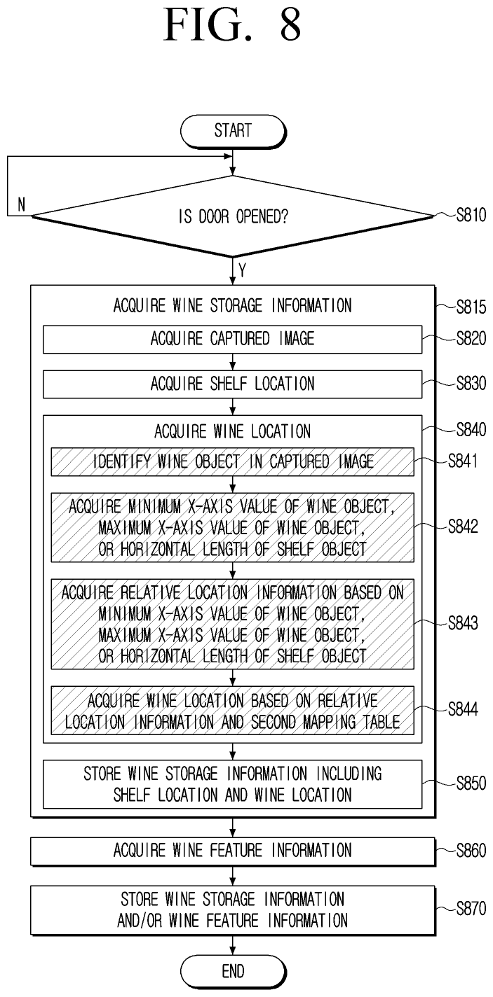

FIG. 8 is a diagram for describing an operation of acquiring the wine location according to an embodiment.

Referring to FIG. 8, steps S810, S815, S820, S830, S840, S850, S860, and S870 may correspond to steps S510, S515, S560, and S570 of FIG. 5. Steps S810, S815, S820, S830, S840, S850, S860, and S870 may correspond to steps S610, S615, S620, S630, S640, S650, S660, and S670 of FIG. 6. Steps S810, S815, S820, S830, S840, S850, S860, S870 may correspond to steps S710, S715, S720, S730, S740, S750, S760, S770 of FIG. 7.

Referring to FIG. 8, the electronic apparatus 100 may identify the wine object in the captured image (S841). The electronic apparatus 100 may acquire at least one of a minimum x-axis value x1 of the wine object, a maximum x-axis value x2 of the wine object, or the horizontal length of the shelf object (S842).

The x-axis of the wine object may be described as the first axis. The electronic apparatus 100 may acquire the coordinate information indicating the wine object. The electronic apparatus 100 may acquire the minimum x-axis value x1 of the coordinates indicating the wine object. The electronic apparatus 100 may acquire the maximum x-axis value x2 of the coordinates indicating the wine object. A description of this configuration is provided with reference to FIG. 15.

The electronic apparatus 100 may acquire the relative location information of the wine based on at least one of the minimum x-axis value x1 of the wine object, the maximum x-axis value x2 of the wine object, or the horizontal length of the shelf object (S843).

The relative location information may indicate where the coordinates of the wine object are relatively placed in the entire region of the shelf. The relative location information may be determined in a range of 0 to 1. For example, the relative location information may be 0 if the wine is placed on the far left of the shelf. The relative location information may be 1 if the wine is placed on the far right of the shelf.

The electronic apparatus 100 may acquire the wine location based on the relative location information of the wine and the second mapping table (S844). The second mapping table may be a mapping table used to specify the wine location. The second mapping table may include information used to specify a location corresponding to the relative location information. A description of this configuration is provided with reference to FIG. 16.

FIG. 9 is a diagram for describing a structure of the shelf included in the electronic apparatus 100 according to an embodiment.

Referring to FIG. 9, the electronic apparatus 100 may include a plurality of shelves 10-1, 10-2, 10-3, 10-4, 10-5, 10-6, 10-7, 10-8, 10-9, 10-10, 10-11, and 10-12. Each shelf may be disposed in the vertical direction. Each shelf location may have a different arrangement structure depending on the type of the electronic apparatus 100. The camera 190 may be disposed on the front surface of the electronic apparatus 100. The camera 190 may be disposed in a direction to capture the plurality of shelves 10-1 to 10-12. The camera 190 may be disposed to face a floor surface in a horizontal direction.

The plurality of shelves 10-1 to 10-12 may be disposed inside the electronic apparatus 100 while a door 30 of the electronic apparatus 100 is closed. The plurality of shelves 10-1 to 10-12 may be moved (or slid) from the inside to the outside of the electronic apparatus 100 while the door 30 is opened. The plurality of shelves 10-1 to 10-12 may be moved from the outside to the inside of the electronic apparatus 100.

According to an embodiment, the plurality of shelves 10-1 to 10-12 may be moved by the physical force applied by the user.

According to an embodiment, the plurality of shelves 10-1 to 10-12 may be automatically moved by a motor included in the electronic apparatus 100.

FIG. 10 is a diagram for describing an operation of identifying the shelf object by using the image according to an embodiment.

According to reference numeral 1010 of FIG. 10, the electronic apparatus 100 may identify the shelf object in the captured image. The electronic apparatus 100 may identify the coordinate information indicating the shelf object. The electronic apparatus 100 may acquire coordinate information 1010-B of the shelf object. The coordinate information 1010-B may include a boundary box or the bounding box.

The electronic apparatus 100 may acquire vertex coordinates 1011, 1012, 1013, and 1014 based on the coordinate information indicating the shelf object. The shelf object identified in the captured image may include four vertices. The first vertex 1011, the second vertex 1012, the third vertex 1013, and the fourth vertex 1014 may be identified.

The electronic apparatus 100 may identify two vertices disposed relatively inside the electronic apparatus 100 among the plurality of vertices. The two vertices disposed relatively inside the electronic apparatus 100 may be the first vertex 1011 and the second vertex 1012.

The electronic apparatus 100 may identify two vertices disposed relatively outside the electronic apparatus 100 among the plurality of vertices. The two vertices disposed relatively outside the electronic apparatus 100 may be the third vertex 1013 and the fourth vertex 1014.

The electronic apparatus 100 may acquire a horizontal length d1 of a lower side of the shelf object connecting the first vertex 1011 to the second vertex 1012.

The electronic apparatus 100 may acquire a horizontal length d2 of an upper side of the shelf object connecting the third vertex 1013 to the fourth vertex 1014.

According to reference numeral 1020 of FIG. 10, the electronic apparatus 100 may acquire coordinate information 1020-B of the shelf object in the rectangular shape. The electronic apparatus 100 may acquire the coordinate information 1020-B indicating the shelf object based on the horizontal length d1 of the lower side of the shelf object.

The electronic apparatus 100 may acquire the horizontal length d1 of the lower side of the shelf object connecting a first vertex 1021 to a second vertex 1022. The electronic apparatus 100 may generate the coordinate information 1020-B of the shelf object for the horizontal length d1 of the lower side of the shelf object and the horizontal length of the upper side of the shelf object to be the same as each other. The electronic apparatus 100 may determine locations of third and fourth vertices 1023 and 1024 for the horizontal length d1 of the lower side of the shelf object and the horizontal length of the upper side of the shelf object to be the same as each other.

FIG. 11 is a diagram for describing an operation of identifying the shelf location by using the image according to an embodiment.

Referring to FIG. 11, the electronic apparatus 100 may acquire the coordinate information of the shelf object. The coordinate information may have the rectangular shape as shown in reference numeral 1020 of FIG. 10. The electronic apparatus 100 may acquire the horizontal length of the shelf object based on the coordinate information. The electronic apparatus 100 may specify the shelf location based on the horizontal length of the shelf object. The shelf location and the location of the camera 190 may be fixed, and the electronic apparatus 100 may specify the shelf location (layer) based on the horizontal length of the shelf object.

Referring to reference numeral 1110 of FIG. 11, the electronic apparatus 100 may acquire coordinate information 1110-B of the shelf object based on the captured image of the twelfth shelf 10-12 (see FIG. 10). The electronic apparatus 100 may acquire the horizontal length (482 pixels) of the shelf object based on the coordinate information 1110-B. The electronic apparatus 100 may identify that the shelf object is the twelfth shelf 10-12 (see FIG. 10) based on the horizontal length (482 pixels).

Referring to reference numeral 1120 of FIG. 11, the electronic apparatus 100 may acquire coordinate information 1120-B of the shelf object based on the captured image of the first shelf 10-1 (see FIG. 10). The electronic apparatus 100 may acquire the horizontal length (119 pixels) of the shelf object based on the coordinate information 1120-B. The electronic apparatus 100 may identify that the shelf object is the first shelf 10-1 (see FIG. 10) based on the horizontal length (119 pixels).

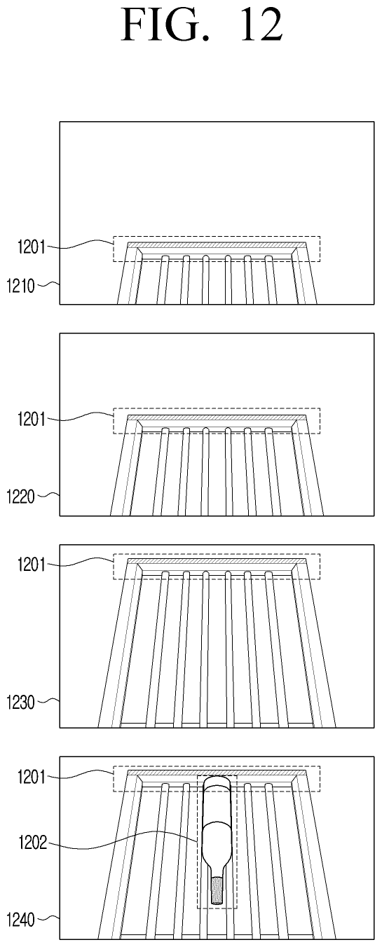

FIG. 12 is a diagram for describing a time point for identifying the shelf object.

Referring to FIG. 12, the electronic apparatus 100 may identify movement of the shelf object in real time. The electronic apparatus 100 may determine in real time whether the shelf object is identified in the captured image. The electronic apparatus 100 may acquire the captured image in real time from a time point at which the door is opened. The electronic apparatus 100 may determine whether the shelf object is identified in the captured image.

The shelf may be fixed to the electronic apparatus 100, and the shelf object may thus always be the same. The electronic apparatus 100 may pre-store information on the shelf object. The electronic apparatus 100 may identify the presence of the shelf object by using only partial features, even if an entire shape of the shelf object is not recognized.

For example, a predetermined feature object 1201 may be present at an upper side part of the shelf. The predetermined feature object 1201 may be an object indicating the upper side of the shelf object. The predetermined feature object 1201 may include a horizontal object having a predetermined color and/or a predetermined thickness.

The electronic apparatus 100 may determine that the shelf object is identified if the predetermined feature object 1201 is identified as being included in the captured image. The electronic apparatus 100 may identify in real time a situation where the shelf is present inside the electronic apparatus 100 and then moved (or slid) outward.

Reference numeral 1210 of FIG. 12 may indicate the captured image acquired at a second time point after a first time point at which the door is opened. The captured image acquired at the second time point may include only a part of the entire region of the shelf object. The captured image may include the predetermined feature object 1201. The electronic apparatus 100 may recognize the shelf object by identifying the predetermined feature object 1201 in the captured image.

Reference numeral 1220 of FIG. 12 may indicate the captured image acquired at a third time point after the second time point. The shelf may be moved further outward at the third time point than at the second time point. The shelf object may be identified more in the captured image acquired at the third time point than in the captured image acquired at the second time point.

Reference numeral 1230 of FIG. 12 may indicate the captured image acquired at a fourth time point after the third time point. The shelf may be moved further outward at the fourth time point than at the third time point. Reference numeral 1230 may indicate that the shelf is moved to the end.

Reference numeral 1240 of FIG. 12 may indicate the captured image acquired at a fifth time point after the fourth time point. The fifth time point may be the time point after the user locates the wine on the shelf. The captured image acquired at the fifth time point may include a wine object 1202.

The shelf location may be computed at various time points. The computation operation of the shelf location may be performed at the various time points.

According to an embodiment, the electronic apparatus 100 may compute the shelf location if a predetermined object 1201 is identified. The electronic apparatus 100 may identify a portion of the shelf object based on the predetermined object 1201. The electronic apparatus 100 may specify the shelf location based on a horizontal length of a lower side of a portion of the shelf object. The horizontal length of the lower side of the shelf object identified in the captured image may be constant regardless of Embodiments 1210 to 1240. The electronic apparatus 100 may compute the shelf location even if not all portions of the shelf object are included in the captured image, as in Embodiments 1210 and 1220.

According to an embodiment, the electronic apparatus 100 may compute the shelf location if the shelf object is stationary. The electronic apparatus 100 may compute the shelf location if the shelf object stops its movement. The electronic apparatus 100 may compute the shelf location if all the portions of the shelf object are included in the captured image, as in Reference numeral 1230.

According to an embodiment, the electronic apparatus 100 may identify the shelf object if both the shelf object and the wine object are included in the captured image.

According to an embodiment, the electronic apparatus 100 may identify whether the wine object is included in the captured image if the shelf object is identified in the captured image. The electronic apparatus 100 may compute the shelf location if the wine object is identified.

According to an embodiment, the electronic apparatus 100 may identify whether the shelf object is included in the captured image if the wine object is identified in the captured image. The electronic apparatus 100 may compute the shelf location if the shelf object is identified.

The wine object may also be moved in the same way as the shelf object described with reference to FIG. 12. The wine object may have a different movement path depending on the user, even though the shelf object has a fixed size (assuming the same shelf) and is moved along a fixed path. The electronic apparatus 100 may determine whether the wine object is being moved or stationary.

The electronic apparatus 100 may determine whether the location of the wine object is fixed for the predetermined time (or threshold time) based on the plurality of captured images acquired in real time. The electronic apparatus 100 may determine that the wine object is identified if the location of the wine object is fixed for the predetermined time. The electronic apparatus 100 may identify the location of the shelf object if the location of the wine object is fixed for the predetermined time. The electronic apparatus 100 may compute the shelf location if the wine object is fixed for the predetermined time and the shelf object is identified.

FIG. 13 is a diagram for describing a table including information for specifying the shelf location.

A first mapping table 1310 of FIG. 13 may indicate a mapping table used to specify the shelf location. The first mapping table 1310 may include information on the horizontal length recognized in the captured image based on the arrangement location (or arrangement height) of the shelf. d may indicate the horizontal length acquired by actually measuring the shelf. d may indicate the horizontal length of the shelf (e.g., twelfth shelf) that is present at the highest location in the captured image. A unit of d may be mm, cm, pixel, or the like.

The lower the shelf location is, the smaller the horizontal length of the shelf measured in the captured image may be. A description of this configuration is already provided with reference to FIG. 11.

A range (e.g., lower limit or upper limit) corresponding to each shelf described in the first mapping table may vary depending on the type of the shelf, a type of the camera, a set value (e.g., resolution or magnification) of the camera included in the electronic apparatus 100. A constant value multiplied by d in the first mapping table may vary depending on a user setting.

The electronic apparatus 100 may acquire the horizontal length of the shelf object. The electronic apparatus 100 may identify the shelf corresponding to the horizontal length of the shelf object by considering the first mapping table 1310. For example, the electronic apparatus 100 may identify the shelf object as the second shelf if the horizontal length of the shelf object is identified as 0.18 d.

FIG. 14 is a diagram for describing an operation of identifying the wine location by using the image according to an embodiment.

Referring to reference numeral 1410 of FIG. 14, the shelf may include the plurality of regions in which the wine may be placed. The shelf may include a column that supports an interior of the shelf. If the number of columns is n, the number of the plurality of regions included in the shelf may be n+1.

For example, the shelf may include seven regions 20-1, 20-2, 20-3, 20-4, 20-5, 20-6, and 20-7 if the shelf having the quadrilateral shape has six internal columns. The wine may be placed in each of the seven regions 20-1, 20-2, 20-3, 20-4, 20-5, 20-6, and 20-7. The electronic apparatus 100 may identify in which of the seven regions 20-1, 20-2, 20-3, 20-4, 20-5, 20-6, and 20-7 the wine is stored.

Referring to reference numeral 1420 of FIG. 14, the electronic apparatus 100 may determine that the wine object is stored in the fourth region 20-4 based on the captured image.

Referring to reference numeral 1430 of FIG. 14, a storage direction of the wine object may be reversed unlike reference numeral 1420. The electronic apparatus 100 may determine that the wine object is stored in the fourth region 20-4 regardless of the storage direction of the wine object.

FIG. 15 is a diagram for describing an operation of identifying the wine object by using the image according to an embodiment.

Referring to reference numeral 1510 of FIG. 15, the electronic apparatus 100 may identify the wine location based on the captured image acquired in reference numeral 1010 of FIG. 10. The electronic apparatus 100 may identify coordinate information 1510-B of the wine object placed on the shelf object. The coordinate information 1510-B of the wine object may identify a first vertex 1511, a second vertex 1512, a third vertex 1513, and a fourth vertex 1514.

The electronic apparatus 100 may identify the minimum x-axis value x1 among all the coordinate values indicating the wine object based on the coordinate information 1510-B of the wine object. The electronic apparatus 100 may identify the maximum x-axis value x2 among all the coordinate values indicating the wine object based on the coordinate information 1510-B of the wine object. The x-axis may be described as the predetermined axis. The x-axis may be parallel to a horizontal line indicating the horizontal length of the shelf object.

The electronic apparatus 100 may identify the wine location based on the horizontal length d1 of the shelf object, the minimum x-axis value x1 of the wine object, and the maximum x-axis value x2 of the wine object. The electronic apparatus 100 may compute the relative location information of the wine object in the entire shelf object. A description of this configuration is provided with reference to FIG. 16.

Referring to reference numeral 1520 of FIG. 15, the electronic apparatus 100 may identify the wine location based on the captured image acquired in reference numeral 1020 of FIG. 10. The electronic apparatus 100 may identify the coordinate information 1520-B of the wine object placed on the shelf object. Other operations may correspond to reference numeral 1510 of FIG. 15.

The coordinate information indicating the shelf object in Embodiments 1510 and 1520 may be partially different from each other. The identified shelf location and wine location may be the same as each other.

FIG. 16 is a diagram for describing a table including the information for specifying the wine location according to an embodiment.

Referring to reference numeral 1610 of FIG. 16, the electronic apparatus 100 may compute the relative location information of the wine (or wine object).

xt may indicate the minimum x-value of the shelf object. The minimum x-value may indicate the minimum x-axis value among the coordinate information of the shelf object.

cx may indicate the relative location information. The relative location information may include values that indicate the relative location.

x1 may indicate the minimum x-value of the wine object. The minimum x-value may indicate the minimum x-axis value among the coordinate information of the wine object.

x2 may indicate the maximum x-value of the wine object. The maximum x-value may indicate the maximum x-axis value among the coordinate information of the wine object.

d1 may indicate the horizontal length of the shelf object acquired in the captured image.

The electronic apparatus 100 may acquire an x-axis center value (x1+x2/2) of the wine object by adding the minimum x-value x1 of the wine object and the maximum x-value x2 of the wine object and dividing the same by 2.

The electronic apparatus 100 may subtract the minimum x-axis value among the coordinate information of the shelf object from the x-axis center value (x1+x2/2) of the wine object.

The electronic apparatus 100 may acquire relative location information cx by dividing a subtraction value {(x1+x2/2)−xt} by the horizontal length d1 of the shelf object.

The electronic apparatus 100 may identify the wine location based on the relative location information cx and a second mapping table 1620. The second mapping table 1620 may indicate a mapping table that includes the relative location range corresponding to each of the plurality of regions included in the shelf.

The electronic apparatus 100 may identify the wine object as being placed in the first region if the relative location information of the wine object is greater than 0 and less than or equal to 0.14.

The electronic apparatus 100 may identify the wine object as being placed in the second region if the relative location information of the wine object is greater than 0.14 and less than or equal to 0.29.

The electronic apparatus 100 may identify the wine object as being placed in the third region if the relative location information of the wine object is greater than 0.29 and less than or equal to 0.43.

The electronic apparatus 100 may identify the wine object as being placed in the fourth region if the relative location information of the wine object is greater than 0.43 and less than or equal to 0.57.

The electronic apparatus 100 may identify the wine object as being placed in the fifth region if the relative location information of the wine object is greater than 0.57 and less than or equal to 0.71.

The electronic apparatus 100 may identify the wine object as being placed in the sixth region if the relative location information of the wine object is greater than 0.71 and less than or equal to 0.86.

The electronic apparatus 100 may identify the wine object as being placed in the seventh region if the relative location information of the wine object is greater than 0.86 and less than or equal to 1.

According to the various embodiments, the electronic apparatus 100 may compute the relative location by using only one value instead of using both the minimum x-value x1 of the wine object and the maximum x-value x2 of the wine object. Although the accuracy may be lower than the case of using both the values, in order to reduce a computation process, the electronic apparatus 100 may compute the relative location by using only the minimum x-value x1 of the wine object or the maximum x-value x2 of the wine object. If one value is used, the remaining values may be computed as 0.

According to the various embodiments, the shelf object may be separated, and the relative location may be computed as shown in FIG. 17. The electronic apparatus 100 may extract (or crop) the region indicating the shelf object based on the first coordinate information indicating the shelf object. The electronic apparatus 100 may compute values x1 and x2 based on the extracted region. xt may be computed as 0.

FIG. 17 is a diagram for describing an operation of cropping the image according to an embodiment.

Referring to reference numeral 1710 of FIG. 17, the electronic apparatus 100 may extract only a portion including the shelf object and the wine object from the captured image acquired in reference numeral 1010 of FIG. 10. The electronic apparatus 100 may perform an image extraction (or segmentation) operation to efficiently manage a data processing speed and a data processing amount without analyzing all portions of the captured image. The electronic apparatus 100 may acquire an extracted image by separating the shelf object and the region including the wine object from the captured image. The electronic apparatus 100 may compute the wine location based on the extracted image. A computation process is described with reference to FIGS. 15 and 16.

Referring to reference numeral 1720 of FIG. 17, the electronic apparatus 100 may extract only the portion including the shelf object and the wine object from the captured image acquired in reference numeral 1020 of FIG. 10. The description other than this configuration may be the same as that in reference numeral 1710. A computation process is described with reference to FIGS. 15 and 16.

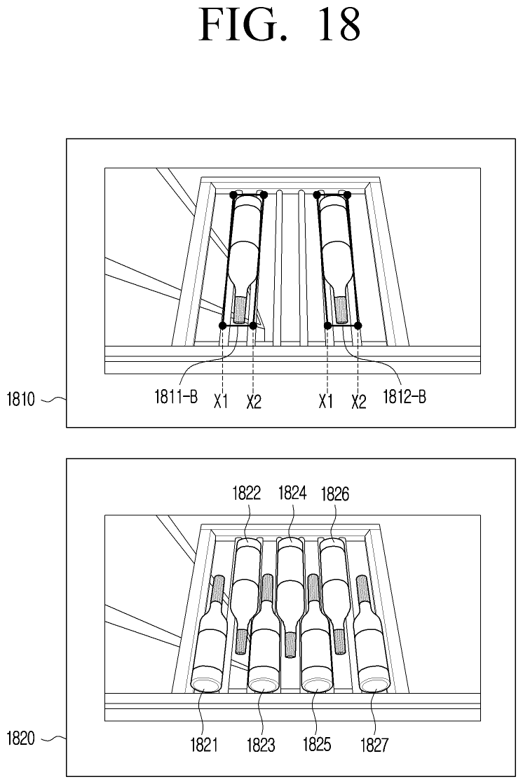

FIG. 18 is a diagram for describing an operation of identifying the plurality of wines according to an embodiment.

Referring to reference numeral 1810 of FIG. 18, the electronic apparatus 100 may identify the plurality of wine objects in the captured image. The electronic apparatus 100 may acquire coordinate information 1811-B and 1812-B of each of the plurality of wine objects. The electronic apparatus 100 may identify the location of each of the plurality of wine objects based on each coordinate information.

For example, the plurality of wine objects may include a first wine object and a second wine object. The electronic apparatus 100 may acquire the first coordinate information 1811-B of the first wine object. The electronic apparatus 100 may identify the first wine object as being placed in the second region based on the first coordinate information 1811-B.

The electronic apparatus 100 may acquire the second coordinate information 1812-B of the second shelf object. The electronic apparatus 100 may identify the second wine object as being placed in the sixth region based on the second coordinate information 1812-B.

Referring to reference numeral 1820 of FIG. 18, the electronic apparatus 100 may acquire the captured image including a plurality of wine objects 1821, 1822, 1823, 1824, 1825, 1826, and 1827, whose storage directions are different. The captured image may include the wine objects 1821, 1823, 1825, and 1827 stored in the first direction and the wine objects 1822, 1824, and 1826 stored in a second direction opposite to the first direction.

The electronic apparatus 100 may identify the wine location regardless of the storage direction of the wine object. The electronic apparatus 100 may identify that the first wine object is placed in the first region, the second wine object is placed in the second region, the third wine object is placed in the third region, the fourth wine object is placed in the fourth region, the fifth wine object is placed in the fifth region, the sixth wine object is placed in the sixth region, and the seventh wine object is placed in the seventh region.

FIG. 19 is a diagram for describing an operation of acquiring the wine feature information by using a wine server according to an embodiment.

Referring to reference numeral 1900 of FIG. 19, the electronic apparatus 100 may acquire the wine feature information. The electronic apparatus 100 may acquire the captured image. The electronic apparatus 100 may extract (or acquire) the wine image including the wine object from the captured image. The electronic apparatus 100 may transmit the wine image to the server 200.

The server 200 may receive the wine image from the electronic apparatus 100. The server 200 may acquire the wine feature information based on the received wine image. The wine feature information may include the various information related to the wine feature. The server 200 may acquire (or search) the wine feature information corresponding to the wine image from various the wine information stored in the database. The server 200 may transmit the wine feature information to the electronic apparatus 100.

The electronic apparatus 100 may receive the wine feature information from the server 200. The electronic apparatus 100 may store the wine feature information.

According to an embodiment, the electronic apparatus 100 may transmit the captured image instead of the wine image to the server 200. The electronic apparatus 100 may transmit the captured image (or original image) instead of the wine image including only the wine object to the server 200. The server 200 may identify the wine object in the captured image, and acquire the wine feature information based on the image region corresponding to the wine object.

According to an embodiment, the electronic apparatus 100 may acquire the wine feature information only by using the database inside the electronic apparatus 100 in the form of an on-device without using the server 200.

FIG. 20 is a diagram for describing an operation of displaying the wine information according to an embodiment.

Referring to FIG. 20, the electronic apparatus 100 may provide a screen 2000 including information related to the wine. The screen 2000 may be a screen to provide information on target wine.

The target wine may be at least one of wine selected by the user, newly registered wine, or the newly stored wine. The screen 2000 may include at least one of a region 2010 indicating the location of the shelf on which the target wine is stored, a region 2020 indicating the wine image including the target wine, or a region 2030 indicating the wine feature information.

The region 2010 may include a UI 2011 that indicates the shelf on which the target wine is stored among the plurality of shelves included in the electronic apparatus 100.

The region 2020 may include an image indicating the target wine. The image indicating the target wine may be either a predetermined wine sample image or the wine image extracted from the captured image. The predetermined wine sample image may be the image indicating the target wine. The predetermined wine sample image may be an image pre-stored in the database or the like. The extracted wine image may indicate an image acquired by extracting a portion of the captured image, where the wine object is displayed, from the captured image acquired using the camera 190 included in the electronic apparatus 100.

The region 2030 may be a region indicating information on the wine feature information acquired by the electronic apparatus 100. The region 2030 may include various information on the target wine. The region 2030 may include the name, type, flavor, manufacturer, manufacturing date, expiration date, price, rating, or the like of the target wine.

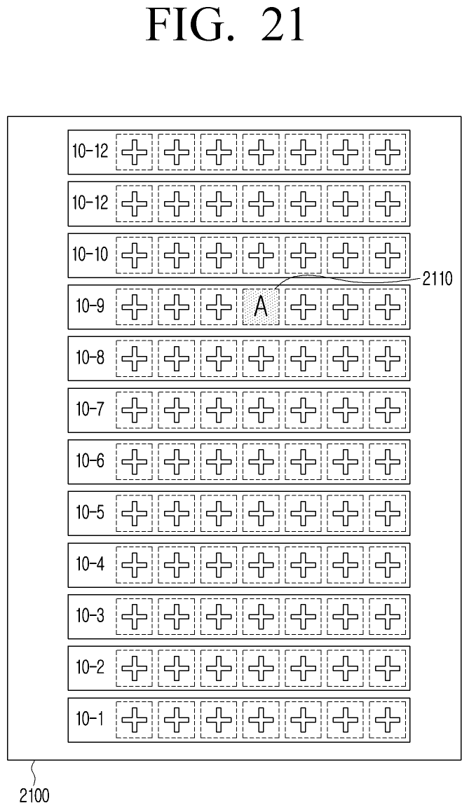

FIG. 21 is a diagram for describing an operation of displaying the wine location according to an embodiment.

Referring to FIG. 21, the electronic apparatus 100 may provide a screen 2100 indicating the wine storage information. The screen 2100 may include a structure of the plurality of shelves 10-1, 10-2, 10-3, 10-4, 10-5, 10-6, 10-7, 10-8, 10-9, 10-10, 10-11, and 10-12 included in the electronic apparatus 100.

The screen 2100 may include a UI 2110 that indicates where the target wine is stored among the plurality of shelves. It is assumed that the target wine is stored in the fourth region of the ninth shelf 10-9. The electronic apparatus 100 may indicate the UI 2110 that indicates the storage location of the target wine.

The UI 2110 may include at least one of text information indicating the state of the target wine, an image related to the wine, or an image related to a wine label. The image may include a thumbnail image.

According to an embodiment, the UI 2110 may include the text information indicating name information of the target wine. The text information included in the UI 2110 may indicate the full name or partial name of the target wine. The partial name may indicate initial information. For example, the UI 2110 may include only initial information A indicating the first letter of the full name ABC of the wine. The user may recognize the name of the target wine through the UI 2110 included in the screen 2100.

According to an embodiment, the UI 2110 may include the text information indicating an open state of the target wine. The UI 2110 may include “O” if the target wine is opened. “O” may indicate that the wine is opened. The UI 2110 may include “N” if the target wine is unopened. “N” may indicate the new wine. The user may recognize whether the target wine is opened through the UI 2110 included in the screen 2110.

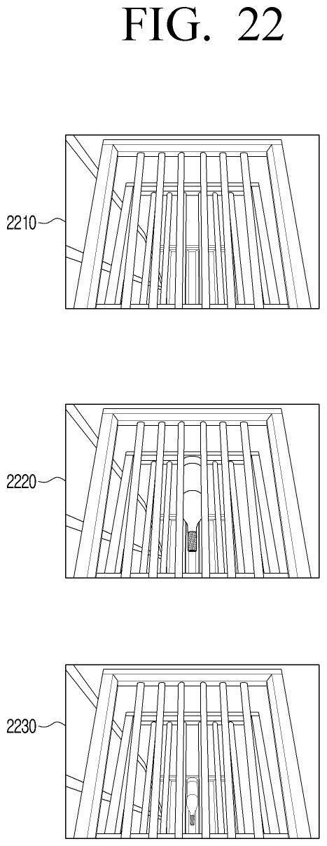

FIG. 22 is a diagram for describing a situation where the plurality of shelves are included in one image according to an embodiment.

Referring to reference numeral 2210 of FIG. 22, the electronic apparatus 100 may acquire the captured image that is captured while the plurality of shelves are open. The electronic apparatus 100 may identify that the plurality of shelves are opened through the captured image. The plurality of shelves objects may be identified in the captured image.

Referring to reference numeral 2220 of FIG. 22, the electronic apparatus 100 may identify the shelf on which the wine is placed among the plurality of shelves. The electronic apparatus 100 may identify the wine object based on the captured image and the shelf object on which the wine object is placed.

Referring to reference numeral 2230 of FIG. 22, the electronic apparatus 100 may not be able to identify the shelf on which the wine object is placed among the plurality of shelves. The electronic apparatus 100 may have difficulty in specifying the shelf on which the wine object is placed if the plurality of shelves objects overlap each other. If the shelf on which the wine is placed is not identified, the electronic apparatus 100 may provide a notification related to this situation to the user. The user may push the shelf that is unnecessarily opened based on the received notification.

The electronic apparatus 100 may determine whether the plurality of shelves objects are identified in the captured image. The electronic apparatus 100 may separate the wine object and a background object (or region) from each other by using the artificial intelligence (AI) model if the plurality of shelves objects are identified. The electronic apparatus 100 may identify the shelf object that is covered by the wine object. The electronic apparatus 100 may identify the shelf object placed on the uppermost side if the plurality of shelf objects are covered by the wine objects.

The electronic apparatus 100 may acquire the coordinate information (or bounding box) corresponding to the identified shelf object. The electronic apparatus 100 may identify the wine location based on the acquired coordinate information.

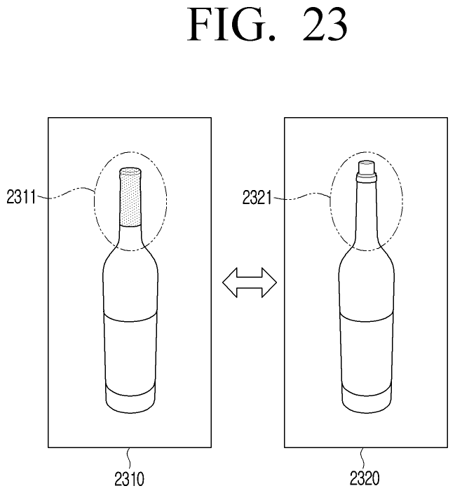

FIG. 23 is a diagram for describing an operation of identifying whether the wine is opened according to an embodiment.

Referring to FIG. 23, the electronic apparatus 100 may identify the open state of the wine. The electronic apparatus 100 may acquire information on the open state of the wine based on the captured image.

An image 2310 of FIG. 23 may include the target wine in the unopen state. The image 2310 may be a sample image and may be a pre-stored image.

An image 2310 of FIG. 23 may be the wine image indicating the wine object included in the captured image.

The electronic apparatus 100 may compare a predetermined region 2311 in the image 2310 and a predetermined region 2321 in an image 2320. The electronic apparatus 100 may acquire the information on the open state of the wine based on a comparison result. The electronic apparatus 100 may acquire similarity between the predetermined regions 2311 and 2321 and acquire the open state information based on the similarity. The electronic apparatus 100 may identify the target wine as being unopened if the similarity is the threshold value or more. The electronic apparatus 100 may identify the target wine as being opened if the similarity is less than the threshold value.

The open state may not indicate a state in which the wine is currently opened and its contents (liquid) may spill. The open state may indicate a state in which the wine has a history of being opened.

A predetermined region may indicate a region around a cork of the wine. The predetermined region may be changed based on the user setting.

The electronic apparatus 100 may consider whether a label is attached, a degree of coupling of the cork, or the like in case of comparing the similarity between the predetermined regions. As an example, the electronic apparatus 100 may determine that the target wine is in the open state if the label covering a neck of the wine object is not present. As an example, the electronic apparatus 100 may determine that the target wine is in the open state if the cork of the wine object is identified by the threshold value or more.

The electronic apparatus 100 may determine whether the stored wine is in the unopen state or in the open state based on the information on the open state of the wine. The electronic apparatus 100 may provide notification information on the wine in the open state if the stored wine is in the open state. The notification information may include information guiding the user to drink the wine in the open state within a short period of time.

The electronic apparatus 100 may identify an event in which the wine in the open state is taken out and the wine in the unopen state is stocked. The electronic apparatus 100 may determine the corresponding wine is preferred by the user if the same type of the wine is taken out and then stocked. The electronic apparatus 100 may update user preference information if the event is identified.

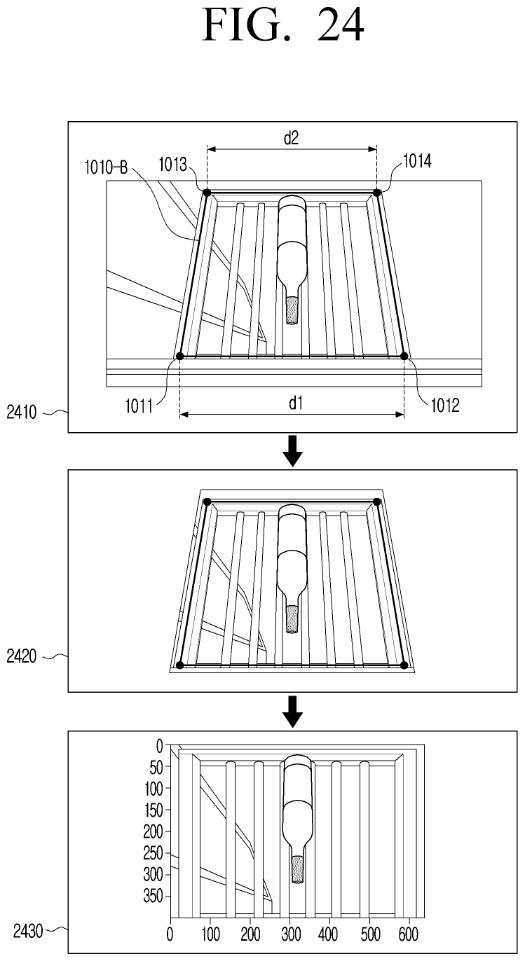

FIG. 24 is a diagram for describing an image conversion operation for the region including the wine object according to an embodiment.

Referring to reference numeral 2410 of FIG. 24, the electronic apparatus 100 may acquire the coordinate information 1010-B indicating the shelf object as in reference numeral 1010 of FIG. 10.

Referring to reference numeral 2420 of FIG. 24, the electronic apparatus 100 may extract (or crop) only the region including the shelf object, as in reference numeral 1710 of FIG. 17. The extracted region may have the trapezoidal shape. The reason is that an object included in the captured image may reflect perspective.

Referring to reference numeral 2430 of FIG. 24, the electronic apparatus 100 may convert the extracted region having the trapezoidal shape into a region having the rectangular shape. The electronic apparatus 100 may perform the image conversion operation by extending the third vertex 1013 to the x-axis coordinate values of the first vertex 1011 and extending the fourth vertex 1014 to the x-axis coordinate values of the second vertex 1012. In the image conversion operation, the coordinate values of a y-axis, which is perpendicular to the x-axis, may be fixed.

The electronic apparatus 100 may identify at least one of the shelf location or the wine location based on a shelf image having the converted rectangular shape. The accuracy of identifying the shelf location and/or the wine location may be improved by reducing distortion of the shelf object having the trapezoidal shape caused by the perspective in case of performing the conversion operation.

FIG. 25 is a diagram for describing an operation of registering a wine image to the electronic apparatus 100 according to an embodiment.

Referring to reference numeral 2510 of FIG. 25, the electronic apparatus 100 may perform the wine registration process by using the camera 190. The wine registration process may indicate an operation of capturing the wine toward the camera 190 before storing the wine on the shelf. The wine registration process may acquire an image that includes the wine object of the threshold size or more. The captured image acquired in the wine registration process is described as a first captured image, and the captured image including the wine stored on the shelf is described as a second captured image. The first captured image may include the wine object of the first size. The second captured image may include the wine object of the second size. The first size may be larger than the second size.

Reference numeral 2520 of FIG. 25 may indicate the captured image acquired in the wine registration process. The electronic apparatus 100 may identify the wine object in the captured image acquired in the wine registration process. The electronic apparatus 100 may acquire the coordinate information of the wine object. The electronic apparatus 100 may acquire size information of the wine object based on the coordinate information of the wine object. The size information of the wine object may indicate the vertical length, diagonal length, or region indicating an area of the wine object.

The electronic apparatus 100 may provide a notification to guide recapturing of the wine if the size information of the wine object is less than the threshold value. The notification may be provided in a form of the audio signal or an image signal. The audio signal may include a voice signal that guides the recapturing. The image signal may include a UI that guides the recapturing.

The electronic apparatus 100 may provide a notification indicating that the wine registration process is completed if the size information of the wine object is the threshold value or more. The notification may be provided in the form of the audio signal or the image signal. The audio signal may include the voice signal or a predetermined beep sound indicating that the wine registration process is completed.

The electronic apparatus 100 may store the captured image as a sample image if the size information of the wine object is the threshold value or more. The sample image may be described as a temporary image or the like.

According to an embodiment, the electronic apparatus 100 may determine the analysis accuracy of the wine object. The analysis accuracy of the wine object may indicate the accuracy of information for analyzing information on the wine object. The analysis accuracy of the wine object may be determined based on at least one of a resolution of the captured image, a size of a text (or image) included in the captured image, and a capture angle of the captured image. The electronic apparatus 100 may acquire the analysis accuracy of the wine object by using the artificial intelligence model. The electronic apparatus 100 may provide the notification to guide the recapturing if the analysis accuracy of the wine object is less than the threshold value.

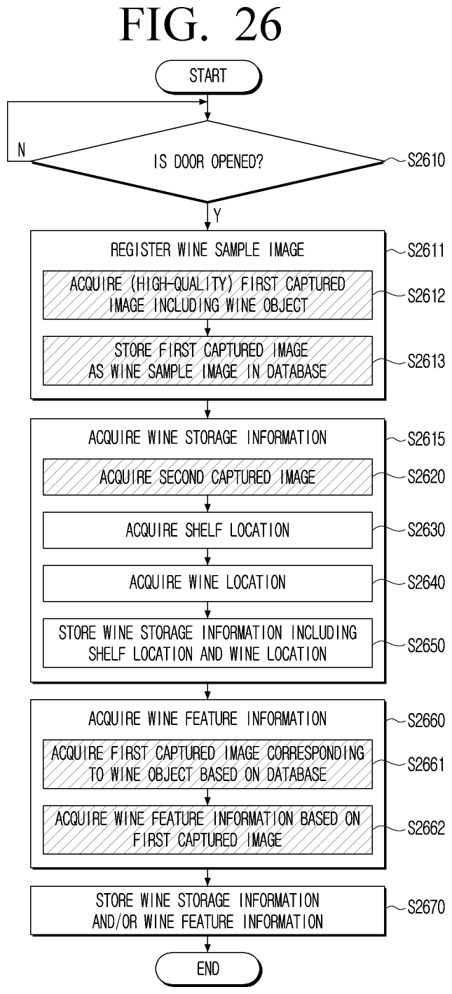

FIG. 26 is a diagram for describing an operation of acquiring the wine feature information by using the registered wine image according to an embodiment.

Referring to FIG. 26, steps S2610, S2615, S2620, S2630, S2640, S2650, S2660, and S2670 may correspond to steps S610, S615, S620, S630, S640, S650, S660, and S670 of FIG. 6.

The electronic apparatus 100 may register the wine sample image (S2611) if the door is opened (S2610-Y). The electronic apparatus 100 may acquire the first captured image including the wine object (S2612) if the door is opened. The electronic apparatus 100 may store the first captured image as the wine sample image in the database (S2613). The wine sample image may be an image in which the wine is captured within the threshold distance from the camera 190. The wine sample image may indicate an image in which the size information of the wine object in the first captured image is the threshold value or more.

According to an embodiment, the electronic apparatus 100 may extract the wine image including only the wine object from the first captured image. The electronic apparatus 100 may store the extracted wine image as the wine sample image in the database.

The electronic apparatus 100 may acquire the second captured image (S2620) after the wine sample image is stored in the database. The second captured image may indicate an image in which the wine is captured while the wine is placed on the shelf. The second captured image may be acquired after a time point at which the first captured image is acquired.

The electronic apparatus 100 may acquire the shelf location and the wine location based on the second captured image (S2630 and S2640). The electronic apparatus 100 may store the wine storage information based on the second captured image (S2650).

The electronic apparatus 100 may acquire the first captured image corresponding to the wine object based on the database (S2661). The electronic apparatus 100 may identify the wine object in the second captured image, and identify (or acquire or search) the first captured image corresponding to the identified wine object from the database.

The electronic apparatus 100 may acquire the wine feature information based on the first captured image (S2662). The first captured image may include the wine object of a size larger than that in the second captured image. The electronic apparatus 100 may acquire the wine feature information based on the first captured image which includes the wine object of the size larger than that in the second captured image. The electronic apparatus 100 may provide the user with a higher accuracy result in case of acquiring the wine feature information based on the first captured image.

The electronic apparatus 100 may determine whether the wine object is identified continuously. The electronic apparatus 100 may track the wine based on the plurality of images acquired in real time.

The electronic apparatus 100 may acquire the wine feature information based on the first captured image if the identified wine object in the first captured image is identified as being moved and stored only within the field of view of the camera 190 based on a wine tracking result. The first captured image may include the wine object of the size larger than that in the second captured image, and the electronic apparatus 100 may thus acquire the wine feature information based on the first captured image with the higher analysis accuracy.

The electronic apparatus 100 may identify whether the wine object identified in the first captured image and the wine object identified in the second captured image are the same as each other by comparing these wine objects if the identified wine object in the first captured image is moved out of the field of view of the camera 190 based on the wine tracking result. The electronic apparatus 100 may identify the wine object in the second captured image.

The electronic apparatus 100 may acquire the wine feature information based on the first captured image if the identified wine object in the first captured image and the wine object identified in the second captured image are the same as each other.

The electronic apparatus 100 may search the database for the wine sample image corresponding to the wine object identified in the second captured image if the wine object identified in the first captured image and the wine object identified in the second captured image are not the same as each other.

The electronic apparatus 100 may search the database for the wine sample image corresponding to the wine object identified in the second captured image. The database may store (or include) at least one wine sample image. The electronic apparatus 100 may search for (or identify) the wine sample image corresponding to the wine object identified in the second captured image among at least one wine sample image stored in the database.

The electronic apparatus 100 may acquire the wine feature information based on the wine sample image if the wine sample image corresponding to the wine object identified in the second captured image is present in the database.

As an example, the electronic apparatus 100 may acquire the wine feature information mapped to the wine sample image if the wine feature information is mapped and stored together with the wine sample image in the database.

The electronic apparatus 100 may acquire the second captured image itself as the wine feature information if the database does not have the wine sample image corresponding to the wine object identified in the second captured image.

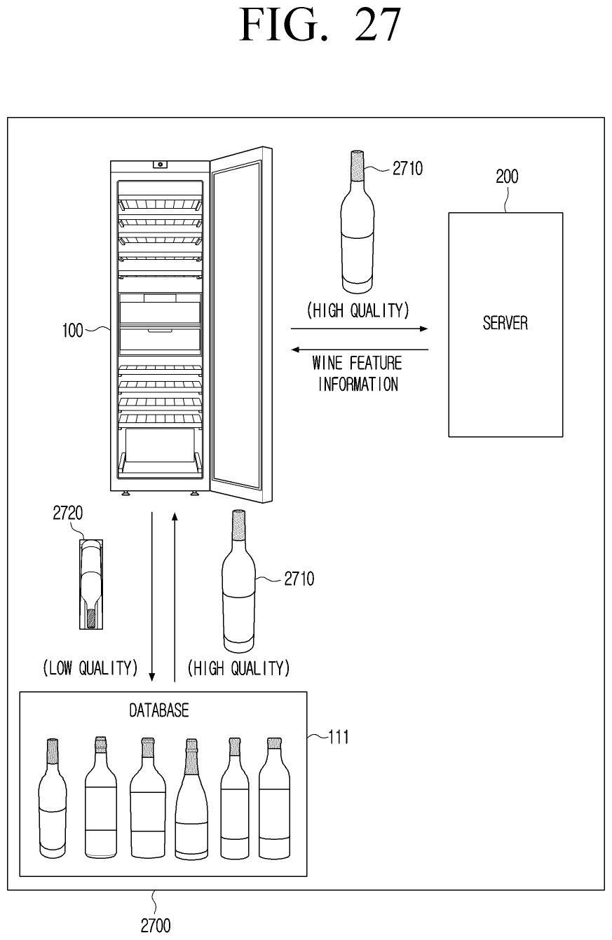

FIG. 27 is a diagram for describing a wine image database according to an embodiment.

Referring to reference numeral 2700 of FIG. 27, it is assumed that the electronic apparatus 100 stores a wine sample image 2710 in a database 111 through the wine registration process. The database 111 may store the plurality of wine sample images 2710 registered in the electronic apparatus 100. The database 111 may store the wine sample image 2710 including the wine object of the threshold size or more. The wine sample image 2710 may be the first captured image.

The electronic apparatus 100 may acquire the second captured image including the wine placed on the shelf while the plurality of wine sample images 2710 are stored in the database 111. The electronic apparatus 100 may acquire a wine image 2720 indicating the wine object in the second captured image.

The electronic apparatus 100 may acquire the wine sample image 2710 corresponding to the wine image 2720 extracted based on the second captured image from the plurality of wine sample images 2710 stored in the database 111. The electronic apparatus 100 may identify and receive the wine sample image 2710 corresponding to the wine image 2720 by using the database 111.

The wine sample image 2710 may include the wine object of a size larger than that in the extracted wine image 2720. The electronic apparatus 100 may transmit the wine sample image 2710 corresponding to the extracted wine image 2720 to the server 200.

The server 200 may acquire the wine sample image 2710 from the electronic apparatus 100. The server 200 may acquire the wine feature information based on the wine sample image 2710. The wine sample image 2710 may include the wine object of the size larger than that in the extracted wine image 2720, and the server 200 may thus acquire accurate wine feature information by using the wine sample image 2710. The server 200 may transmit the wine feature information to the electronic apparatus 100.

The electronic apparatus 100 may receive the wine feature information from the server 200. The electronic apparatus 100 may store the wine feature information.

The wine sample image 2710 may include a high-quality wine object. The extracted wine image 2720 may include a low-quality wine object. The larger the wine object, the higher the image quality may be. A recognition level of the wine feature information may be improved in case of using the high-quality wine object.

The electronic apparatus 100 may include a feature extraction model. The electronic apparatus 100 may input the extracted wine image 2720 into the feature extraction model. The feature extraction model may receive the wine image 2720 as the input data, and acquire the wine sample image 2710 corresponding to the wine image 2720 as output data. The wine image 2720 may be described as the low-quality wine image.

The electronic apparatus 100 may acquire a detailed feature of the low-quality wine image 2720 by using the feature extraction model. The electronic apparatus 100 may acquire the high-quality wine image 2710 corresponding to the low-quality image 2720 among at least one image stored in the database 111 based on the detailed feature of the low-quality wine image 2720. The electronic apparatus 100 may acquire the high-quality wine image 2710 having a higher resolution than the low-quality wine image 2720 by using the detailed feature of the low-quality wine image 2720 acquired by the feature extraction model.

The database 111 may be implemented using various devices. According to an embodiment, the database 111 may be included in the memory 110 of the electronic apparatus 100. According to an embodiment, the database 111 may be included in the server 200.

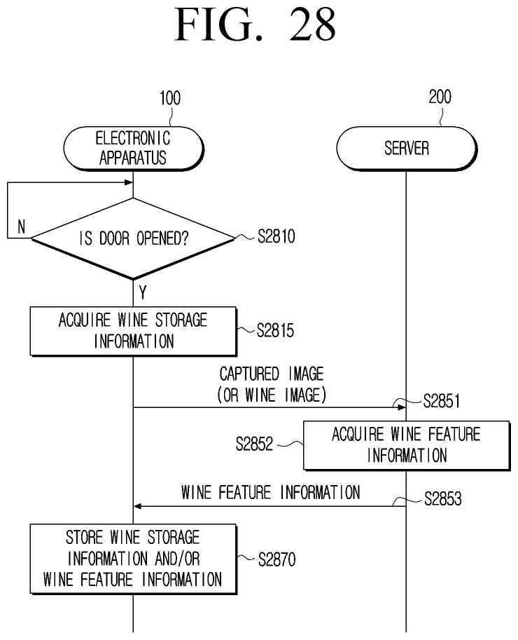

FIG. 28 is a diagram for describing an operation of acquiring the wine feature information by using the server 200 according to an embodiment.

Steps S2810, S2815, and S2870 of FIG. 28 may correspond to steps S510, S515, and S570 of FIG. 5.

The electronic apparatus 100 may transmit the captured image (or wine image) to the server 200 (S2851) after acquiring the wine storage information. The server 200 may receive the captured image (or wine image) from the electronic apparatus 100. The server 200 may acquire the wine feature information based on the captured image (or wine image) (S2852). The server 200 may transmit the wine feature information to the electronic apparatus 100 (S2853).

The electronic apparatus 100 may receive the wine feature information from the server 200. The electronic apparatus 100 may store at least one of the wine storage information or the wine feature information (S2870).

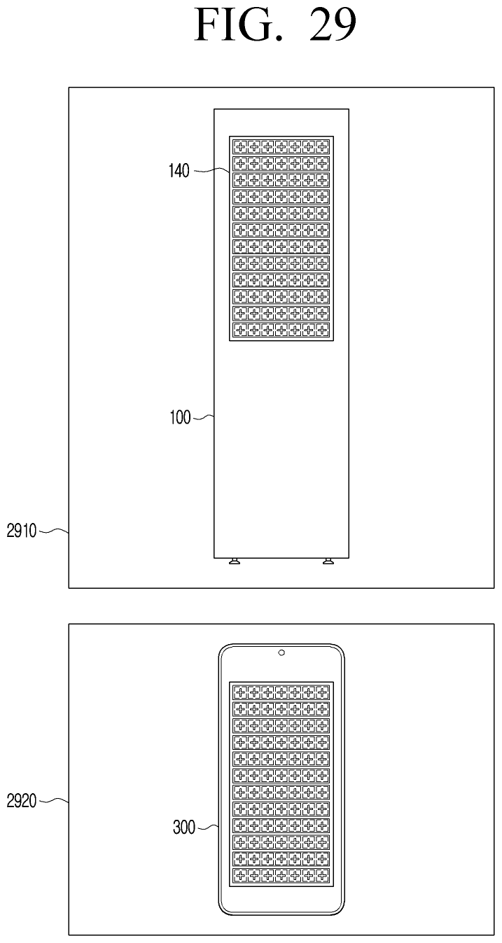

FIG. 29 is a diagram for describing an operation of providing the wine information according to an embodiment.

Referring to FIG. 29, the electronic apparatus 100 may provide a screen including the wine information. The screen including the wine information may be a screen indicating at least one of the wine storage information or the wine feature information.

Referring to reference numeral 2910 of FIG. 29, the electronic apparatus 100 may provide the screen including the wine information through the display 140 of the electronic apparatus 100.

Referring to reference numeral 2920 of FIG. 29, the electronic apparatus 100 may provide the screen including the wine information through the display of the user terminal 300.

FIG. 30 is a diagram for describing an operation of providing the wine information by a user terminal 300 according to an embodiment.

Steps S3010, S3015, S3051, S3052, S3053, and S3070 of FIG. 30 may correspond to steps S2810, S2815, S2851, S2852, S2853, and S2870 of FIG. 28.

The electronic apparatus 100 may transmit the wine information to the server 200 (S3071) after storing the wine information including the wine storage information and/or the wine feature information.

The server 200 may receive the wine information from the electronic apparatus 100. The server 200 may store the wine information (S3072). The user terminal 300 may request the wine information from the server 200 (S3080) while storing the wine information.

The server 200 may receive a wine information request from the user terminal 300. The server 200 may identify the wine information in response to the wine information request. The server 200 may transmit the identified wine information to the user terminal 300 (S3081).

The user terminal 300 may receive the wine information from the server 200. The user terminal 300 may provide the received wine information (S3082).

The description describes that the server acquiring the wine feature information and the server storing the wine information are the same with reference to FIG. 30. According to the various embodiments, a first server storing the wine feature information and a second server storing the wine information may be classified. If the first server and the second server are classified, the user terminal 300 may request the wine information from the second server. The second server may transmit the wine information to the user terminal 300 in response to the request from the user terminal 300.

FIG. 31 is a diagram for describing an operation of providing a user interface (UI) for inputting the wine feature information according to an embodiment.

Steps S3110, S3115, S3151, S3152, S3153, and S3170 of FIG. 31 may correspond to steps S2810, S2815, S2851, S2852, S2853, and S2870 of FIG. 28.

The server 200 may determine whether the wine feature information is identified based on the received captured image (or wine image) (S3151-2) if the captured image (or wine image) is received from the electronic apparatus 100. The server 200 may acquire the wine feature information (S3152) and transmit the wine feature information to the electronic apparatus 100 (S3153) if the wine feature information is identified based on the captured image (or wine image) (S3151-2-Y). The electronic apparatus 100 may store the wine storage information and the wine feature information received from the server 200 (S3170).

The server 200 may transmit a non-identification notification to the electronic apparatus 100 (S3180) if the wine feature information is not identifiable based on the captured image (or wine image) (S3151-2-N). The non-identification notification may include information for notifying that the wine feature information is not identified based on the captured image.

The electronic apparatus 100 may receive the non-identification notification from the server 200. The electronic apparatus 100 may provide the guide UI for inputting the wine feature information (S3181). The guide UI may include at least one of information guiding the user to select information related to the wine feature information or information guiding the user to directly input the wine feature information.

The electronic apparatus 100 may acquire the wine feature information through the guide UI (S3182). As an example, the electronic apparatus 100 may receive a first user input through the guide UI. The first user input may be an input for selecting one of the plurality of wine feature information. As an example, the electronic apparatus 100 may receive a second user input through the guide UI. The second user input may include the wine feature information directly input by the user.

According to the various embodiments, the electronic apparatus 100 may transmit the captured image (or wine image) to the external server before performing steps S3181 and S3182. The electronic apparatus 100 may request the wine feature information from an external server, which is a different sub-server from the server 200, to acquire the wine feature information. The electronic apparatus 100 may request the wine feature information by transmitting the captured image (or wine image) to the external server.

The external server may transmit the wine feature information to the electronic apparatus 100 if the wine feature information is identified by the external server. The external server may transmit the non-identification notification to the electronic apparatus 100 if the wine feature information is not identified by the external server.

The electronic apparatus 100 may perform steps S3181 and S3182 if the non-identification notification is received from the external server.

FIG. 32 is a diagram for describing an operation of providing the UI for inputting the wine feature information by the user terminal 300 according to an embodiment.

Steps S3210, S3215, S3251, S3151-2, S3252, S3253, and S3270 of FIG. 32 may correspond to steps S3110, S3115, S3151, S3151-2, S3152, S3153, and S3170 of FIG. 31.

The server 200 may determine whether the wine feature information is identified based on the captured image (or wine image) received from the electronic apparatus 100 (S3251-2).

The server 200 may transmit the non-identification notification to the user terminal 300 if the wine feature information is not identified based on the captured image (or wine image) (S3151-2-N).

The user terminal 300 may receive the non-identification notification from the server 200. The user terminal 300 may provide the guide UI for inputting the wine feature information (S3281). The guide UI may include at least one of the information guiding the user to select information related to the wine feature information or the information guiding the user to directly input the wine feature information.

The user terminal 300 may acquire the wine feature information through the guide UI (S3282). As an example, the user terminal 300 may receive the first user input through the guide UI. The first user input may be the input for selecting one of the plurality of wine feature information. As an example, the user terminal 300 may receive the second user input through the guide UI. The second user input may include the wine feature information directly input by the user.

The user terminal 300 may transmit the wine feature information acquired through the guide UI to the electronic apparatus 100 (S3283).

The electronic apparatus 100 may receive the wine feature information from the user terminal 300. The electronic apparatus 100 may store at least one of the wine storage information or the wine feature information (S3270).

FIG. 33 is a diagram for describing the UI for inputting the wine feature information according to an embodiment.

Referring to FIG. 33, a screen 3300 for inputting the wine feature information may be provided. The screen 3300 may include at least one of a region 3310 for indicating that the wine feature information is not identifiable, a region 3320 for including an image of the target wine to be analyzed, a region 3300 for indicating that there are no search results for the target wine, a region 3340 for selecting candidate wine, or a region 3350 for guiding direct input of the wine feature information.

The region 3320 may be the image to be analyzed. The region 3320 may include the captured image, the wine image, or the wine sample image.

The region 3340 may include the most similar candidate wine, even though the wine is not identical. The region 3340 may include text information guiding the user to select the wine directly or at least one of the candidate wine images if the candidate wine includes the target wine that the user wants to store.

The region 3350 may include text information guiding the user to directly input the wine feature information.

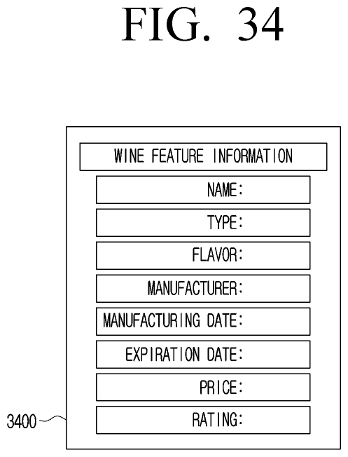

FIG. 34 is a diagram for describing the UI for inputting the wine feature information according to an embodiment.

Referring to FIG. 34, a screen 3400 for the user to directly input the wine feature information may be provided. The screen 3400 may be provided if the user input to select the region 3350 of FIG. 33 is received. The screen 3400 may be a screen for inputting the wine feature information of the target wine.

The user may input at least one of the name, type, flavor, manufacturer, manufacturing date, expiration date, price, or rating of the wine through the screen 3400. The input information may be stored as the wine feature information.

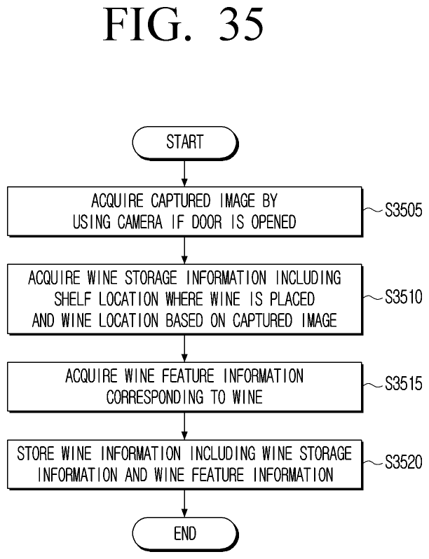

FIG. 35 is a diagram for describing a controlling method of an electronic apparatus 100 according to an embodiment.

Referring to FIG. 35, the controlling method of an electronic apparatus for storing wine may include: acquiring the captured image if the door of the electronic apparatus is opened (S3505); acquiring the wine storage information including the shelf location where wine is placed and the wine location based on the captured image (S3510); acquiring the wine feature information corresponding to the wine (S3515); and storing the wine information including the wine storage information and the wine feature information (S3520).

In the acquiring of the captured image (S3505), the captured image may be acquired if the signal indicating that the door is opened is received.

In the acquiring of the wine storage information (S3510), the shelf object may be identified in the captured image, the horizontal length of the shelf object may be acquired, and the shelf location may be acquired based on the horizontal length of the shelf object and the first mapping table stored in the electronic apparatus, the first mapping table including the horizontal length range corresponding to each of the plurality of shelves of the electronic apparatus.

In the acquiring of the wine storage information (S3510), the first coordinate information corresponding to the shelf object may be acquired based on the captured image, and the outline length of the shelf object in the lowest position may be acquired as the horizontal length of the shelf object based on the first coordinate information.

In the acquiring of the wine storage information (S3510), the plurality of vertices corresponding to the shelf object may be identified based on the first coordinate information, two vertices adjacent to the camera of the electronic apparatus may be identified among the plurality of vertices, and the outline length connecting the two vertices to each other may be acquired as the horizontal length of the shelf object.

In the acquiring of the wine storage information (S3510), the horizontal length range corresponding to the horizontal length may be identified among the plurality of horizontal length ranges included in the first mapping table, and the shelf corresponding to the identified horizontal length range may be identified as the shelf on which the wine is stored.

In the acquiring of the wine storage information (S3510), the shelf location may be identified as being farther away from the camera of the electronic apparatus as the horizontal length is smaller.

In the acquiring of the wine storage information (S3510), the wine object may be identified in the captured image, the relative location information indicating the location of the wine object may be acquired in the entire region of the shelf based on the captured image, and the wine location may be acquired based on the relative location information and the second mapping table stored in the electronic apparatus, the second mapping table including the relative location range corresponding to each of the plurality of regions of the shelf.

In the acquiring of the wine storage information (S3510), the first coordinate information corresponding to the shelf object may be acquired based on the captured image, the outline length of the shelf object in the lowest position may be acquired as the horizontal length of the shelf object based on the first coordinate information, the minimum x-axis value of the shelf object may be acquired based on the first coordinate information, the second coordinate information corresponding to the wine object may be acquired based on the captured image, at least one of the minimum x-axis value of the wine object or the maximum x-axis value of the wine object may be acquired based on the second coordinate information, the relative location information corresponding to the wine object may be acquired based on at least one of the minimum x-axis value of the wine object or the maximum x-axis value of the wine object, the minimum x-axis value of the shelf object, or the horizontal length of the shelf object, and the wine location may be acquired based on the relative location information.

In the acquiring of the wine feature information (S3515), the wine sample image may be stored in the database through the wine registration process, the wine sample image corresponding to the wine object may be acquired if the wine object is identified in the captured image, and the wine feature information may be acquired based on the wine sample image, the wine feature information including at least one of the name, type, flavor, manufacturer, manufacturing date, expiration date, price, or rating of the wine.

The methods according to the various embodiments of the present disclosure described above may be implemented in the form of an application which may be installed on an electronic apparatus.

The methods according to the various embodiments of the present disclosure described above may be implemented only by software upgrade or hardware upgrade of the electronic apparatus.

The various embodiments of the present disclosure described above may be performed using an embedded server included in the electronic apparatus, or the external server of at least one of the electronic apparatus and the display device.

According to an embodiment of the present disclosure, the various embodiments described above may be implemented by software including an instruction stored on a machine-readable storage medium (for example, a computer-readable storage medium). A machine may be a device that invokes the stored instruction from the storage medium, may be operated on the basis of the invoked instruction, and may include the electronic apparatus according to the disclosed embodiments. If the instruction is executed by the processor, the processor may directly perform a function corresponding to the instruction or another component may perform the function corresponding to the instruction under the control of the processor. The instruction may include codes generated or executed by a compiler or an interpreter. The machine-readable storage medium may have the form of a non-transitory storage medium. Here, the term “non-transitory” indicates that the storage medium is tangible without including a signal, and does not distinguish whether data are semi-permanently or temporarily stored on the storage medium.

According to an embodiment of the present disclosure, the methods according to the various embodiments described above may be provided by being included in a computer program product. The computer program product may be traded as a product between a seller and a purchaser. The computer program product may be distributed in a form of machine-readable storage medium (for example, a compact disc read only memory (CD-ROM)) or online through an application store. In case of the online distribution, at least portions of the computer program product may be at least temporarily stored on a storage medium such as a memory of a server of a manufacturer, a server of an application store or a relay server, or be temporarily provided.

Each of the components (for example, modules or programs) according to the various embodiments described above may include one entity or a plurality of entities, and other sub-components may be further included in the various embodiments. Some of the components (e.g., modules or programs) may be integrated into one entity, and may perform functions performed by the respective corresponding components before being integrated in the same or similar manner. Operations performed by the modules, the programs, or other components according to the various embodiments may be executed in a sequential manner, a parallel manner, an iterative manner, or a heuristic manner, at least some of the operations may be performed in a different order, or other operations may be added.

Although the embodiments are shown and described in the present disclosure the present disclosure is not limited to the above-described embodiments, and may be variously modified by those skilled in the art to which the present disclosure pertains without departing from the gist of the present disclosure as claimed in the accompanying claims. These modifications should also be understood to fall within the scope and spirit of the present disclosure.

What is claimed is:

1. An electronic apparatus for storing wine, the electronic apparatus comprising:
a door;
memory storing instructions;
a camera; and
at least one processor,
wherein the instructions, when executed by the at least one processor, cause the electronic apparatus to:
acquire a captured image via the camera based on the door being open;
acquire, based on the captured image, wine storage information comprising a shelf location where a wine object is placed and a wine location of the wine object;
acquire wine feature information corresponding to the wine object;
store wine information comprising the wine storage information and the wine feature information in the memory; and
transmit the wine information to a user terminal to cause the user terminal to display at least one of the wine storage information, the wine feature information, a storage recommendation based on the wine information, or a food pairing recommendation based on the wine information.

2. The electronic apparatus as claimed in claim 1, further comprising a door sensor,
wherein the instructions, when executed by the at least one processor, cause the electronic apparatus to acquire the captured image via the camera based on a signal indicating that the door is open being received via the door sensor.

3. The electronic apparatus as claimed in claim 1, further comprising a plurality of shelves,
wherein the instructions, when executed by the at least one processor, cause the electronic apparatus to:
identify a shelf object in the captured image;
acquire a horizontal length of the shelf object; and
acquire the shelf location based on the horizontal length of the shelf object and a first mapping table stored in the memory,
wherein the first mapping table comprises a plurality of horizontal length ranges corresponding to the plurality of shelves.

4. The electronic apparatus as claimed in claim 3, wherein the instructions, when executed by the at least one processor, cause the electronic apparatus to:
acquire, based on the captured image, first coordinate information corresponding to the shelf object; and
acquire, based on the first coordinate information, a first outline length of the shelf object in a lowest position in the captured image, from among a plurality of shelf objects in the captured image, as the horizontal length of the shelf object.

5. The electronic apparatus as claimed in claim 4, wherein the instructions, when executed by the at least one processor, cause the electronic apparatus to:
identify, based on the first coordinate information, a plurality of vertices corresponding to the shelf object;
identify two vertices adjacent to the camera from among the plurality of vertices; and
acquire, as the horizontal length of the shelf object, a second outline length connecting the two vertices to each other.

6. The electronic apparatus as claimed in claim 3, wherein the instructions, when executed by the at least one processor, cause the electronic apparatus to:
identify a horizontal length range corresponding to the horizontal length of the shelf object from among the plurality of horizontal length ranges; and
identify a first shelf corresponding to the horizontal length range as a shelf on which the wine object is stored.

7. The electronic apparatus as claimed in claim 3, wherein the instructions, when executed by the at least one processor, cause the electronic apparatus to identify the shelf location based on the horizontal length of the shelf object, wherein the shelf object is determined to be a further distance from the camera as the horizontal length of the shelf object decreases.

8. The electronic apparatus as claimed in claim 6, wherein the instructions, when executed by the at least one processor, cause the electronic apparatus to:
identify the wine object in the captured image;
acquire, based on the captured image, relative location information indicating a location of the wine object in a region of the first shelf; and
acquire the wine location based on the relative location information and a second mapping table stored in the memory,
wherein the second mapping table comprises a plurality of relative location ranges corresponding to a plurality of regions of the plurality of shelves.

9. The electronic apparatus as claimed in claim 8, wherein the instructions, when executed by the at least one processor, cause the electronic apparatus to:
acquire, based on the captured image, first coordinate information corresponding to the shelf object;
acquire, based on the first coordinate information, an outline length of the shelf object in a lower direction as the horizontal length of the shelf object;
acquire, based on the first coordinate information, a first minimum x-axis value of the shelf object;
acquire, based on the captured image, second coordinate information corresponding to the wine object;
acquire, based on the second coordinate information, at least one of a second minimum x-axis value of the wine object or a maximum x-axis value of the wine object;
acquire the relative location information corresponding to the wine object based on at least one of the second minimum x-axis value or the maximum x-axis value of the wine object, the first minimum x-axis value, or the horizontal length of the shelf object; and
acquire the wine location based on the relative location information.

10. The electronic apparatus as claimed in claim 8, wherein the instructions, when executed by the at least one processor, cause the electronic apparatus to:
store a wine sample image in a database through a wine registration process,
acquire a first wine sample image corresponding to the wine object if the wine object is identified in the captured image, and
acquire the wine feature information based on the first wine sample image,
wherein the wine feature information comprises at least one of a name, a type, a flavor, a manufacturer, a manufacturing date, an expiration date, a price, or a rating of the wine.

11. A controlling method of an electronic apparatus for storing wine, the controlling method comprising:
acquiring a captured image, via a camera, based on a door of the electronic apparatus being open;
acquiring, based on the captured image, wine storage information comprising a shelf location where a wine object is placed and a wine location of the wine object;
acquiring wine feature information corresponding to the wine object;
storing wine information comprising the wine storage information and the wine feature information in memory of the electronic apparatus; and
transmitting the wine information to a user terminal to cause the user terminal to display at least one of the wine storage information, the wine feature information, a storage recommendation based on the wine information, or a food pairing recommendation based on the wine information.

12. The controlling method as claimed in claim 11, wherein the acquiring the captured image comprises acquiring the captured image based on a signal from a door sensor being received that indicates the door is open.

13. The controlling method as claimed in claim 11, wherein the acquiring the wine storage information comprises:
identifying a shelf object in the captured image;
acquiring a horizontal length of the shelf object; and
acquiring the shelf location based on the horizontal length of the shelf object and a first mapping table stored in the electronic apparatus,
wherein the first mapping table comprises a plurality of horizontal length ranges corresponding to a plurality of shelves of the electronic apparatus.

14. The controlling method as claimed in claim 13, wherein the acquiring the wine storage information comprises:
acquiring, based on the captured image, first coordinate information corresponding to the shelf object; and
acquiring, based on the first coordinate information, a first outline length of the shelf object in a lowest position in the captured image, from among a plurality of shelf objects in the captured image, as the horizontal length of the shelf object.

15. The controlling method as claimed in claim 14, wherein the acquiring the wine storage information comprises:
identifying, based on the first coordinate information, a plurality of vertices corresponding to the shelf object;
identifying two vertices adjacent to the camera from among the plurality of vertices, and
acquiring, as the horizontal length of the shelf object, a second outline length connecting the two vertices to each other.

16. The controlling method as claimed in claim 13, wherein the acquiring the wine storage information comprises:
identifying a horizontal length range corresponding to the horizontal length of the shelf object from among the plurality of horizontal length ranges; and
identifying a first shelf corresponding to the horizontal length range as a shelf on which the wine object is stored.

17. The controlling method as claimed in claim 13, wherein the acquiring the wine storage information comprises identifying the shelf location based on the horizontal length of the shelf object, wherein the shelf object is determined to be a further distance from the camera as the horizontal length of the shelf object decreases.

18. The controlling method as claimed in claim 16, wherein the acquiring the wine storage information comprises:
identifying the wine object in the captured image;
acquiring, based on the captured image, relative location information indicating a location of the wine object in a region of the first shelf; and
acquiring the wine location based on the relative location information and a second mapping table stored in the memory,
wherein the second mapping table comprises a plurality of relative location ranges corresponding to a plurality of regions of the plurality of shelves.

19. The controlling method as claimed in claim 18, wherein the acquiring the wine storage information comprises:
acquiring, based on the captured image, first coordinate information corresponding to the shelf object;
acquiring, based on the first coordinate information, an outline length of the shelf object in a lower direction as the horizontal length of the shelf object;
acquiring, based on the first coordinate information, a first minimum x-axis value of the shelf object;
acquiring, based on the captured image, second coordinate information corresponding to the wine object;
acquiring, based on the second coordinate information, at least one of a second minimum x-axis value of the wine object or a maximum x-axis value of the wine object;
acquiring the relative location information corresponding to the wine object based on at least one of the second minimum x-axis value or the maximum x-axis value of the wine object, the first minimum x-axis value, or the horizontal length of the shelf object; and
acquiring the wine location based on the relative location information.

20. A non-transitory computer-readable recording medium having instructions recorded thereon, that, when executed by one or more processors, cause the one or more processors to:
acquire a captured image via a camera based on a door of an electronic apparatus for storing wine being open;
acquire, based on the captured image, wine storage information comprising a shelf location where a wine object is placed and a wine location of the wine object;
acquire wine feature information corresponding to the wine object;
store wine information comprising the wine storage information and the wine feature information in memory of the electronic apparatus; and
transmit the wine information to a user terminal to cause the user terminal to display at least one of the wine storage information, the wine feature information, a storage recommendation based on the wine information, or a food pairing recommendation based on the wine information.
